(19) United States
(12) Patent Application Publication
(10) Pub. No.: US 2016/0196760 A1
(43) Pub. Date: Jul. 7, 2016

(54) PORTABLE TERMINAL AND METHOD OF CONTROLLING THEREOF

(71) Applicant: Samsung Electronics Co., Ltd., Gyeonggi-do (KR)

(72) Inventors: Gyo-Seung KOO, Gyeonggi-do (KR); Dong-Hun PARK, Gyeonggi-do (KR); Hee-Jae JUNG, Gyeonggi-do (KR); Jung-Hwan KIM, Seoul (KR); Ji-Ho MA, Gyeonggi-do (KR); Ae-Seon SEO, Seoul (KR); Jung-Ho SEO, Gyeonggi-do (KR)

(21) Appl. No.: 14/985,666

(22) Filed: Dec. 31, 2015

(30) Foreign Application Priority Data
Jan. 5, 2015 (KR) 10-2015-0000717

(51) Int. Cl. G09B 5/02; G09B 19/00

(52) U.S. Cl. CPC G09B 5/02; G09B 19/003

(57) ABSTRACT

Disclosed herein are a portable terminal and method. The portable terminal includes a display module and at least one processor operatively coupled to the memory, which may implemented the method to control the display module to display a first image operable to indicate a state of a user, and in response to receiving response information while the first image is displayed, determine a state of the user according to the received response information.

### CLAIM OF PRIORITY

This application claims priority under 35 U.S.C. §119(a) to Korean Application Serial No. 10-2015-0000717, which was filed in the Korean Intellectual Property Office on Jan. 5, 2015, the entire contents of which are hereby incorporated by reference.

### TECHNICAL FIELD

The present disclosure relates to providing exercise information via a portable terminal and a controlling method thereof.

### BACKGROUND

As portable terminals, such as a smart phone or the like, have rapidly propagated, the era of one-man one-device has come. This means that the portable terminal has become a part of normal life for an average portable terminal user. The portable terminal is increasingly considered an indispensable part of everyday life.

Accordingly, the portable terminal includes various functions, beyond the phone call function and/or Internet search function, that improve the quality of life for users, such as, for example, a health care program that may benefit the user's health. The health care program, for example, may provide a user with a video or a trainer through the portable terminal, and may provide a user with an environment where the user may perform an exercise with the right posture by referencing a provided video.

However, health care programs often provide identical health care programs to all users who use, irrespective of the physical state of each particular user.

Also, in the health care programs, a user typically manually inputs feedback associated with each exercise type included in the health care programs.

Also, the health care programs do not reflect the feedback in real-time, (since it is input by the user) and thus, these programs cannot provide real-time adjustment of the program characteristics (such as intensity) based on the physical capabilities of each respective user.

### SUMMARY

An aspect of the present disclosure is to provide a portable terminal and a controlling method thereof, which may provide an exercise program that is appropriate for the exercise capability of a user by reflecting the physical state of the user who uses the health care program.

Another aspect of the present disclosure is to provide a portable terminal and a controlling method thereof, which may enable a user who uses the health care program to check the posture of the user through the interoperation between a wearable device worn on a body part of the user and the portable terminal according to various embodiments of the present disclosure.

Another aspect of the present disclosure is to provide a portable terminal and a controlling method thereof, which may automatically determine the feedback of a user in association with an exercise type through the wearable device.

Another aspect of the present disclosure is to provide a portable terminal and a controlling method thereof, which may provide a health care program by adjusting, in real time, the level of the health care program based on the exercise capability of a user, which is determined based on the feedback.

According to various embodiments of the present disclosure, a portable terminal is provided, including a display module and at least one processor operatively coupled to memory, configured to: control the display module to display a first image operable to indicate a state of a user, and in response to receiving response information while the first image is displayed, determine a state of the user according to the received response information.

According to various embodiments of the present disclosure, a method in a portable terminal is disclosed, including displaying a first image operable to indicate a state of a user of the portable terminal, and in response to receive response information while the first image is displayed, determining a state of the user according to the received response information.

According to the present disclosure, an exercise program that is appropriate for the exercise capability of a user who uses a health care program may be provided through a portable terminal by reflecting the physical state of the user.

According to the present disclosure, a user who uses a health care program may check the posture of the user via a portable terminal and/or a wearable device, through the interoperation between the wearable device worn on a body part of the user and the portable terminal according to various embodiments of the present disclosure.

Also, according to the present disclosure, the portable terminal may automatically determine the feedback of a user in association with an exercise type, through a wearable device.

According to the present disclosure, a portable terminal may provide a health care program by adjusting, in real time, the level of the health care program based on the exercise capability of a user, which is determined based on the feedback.

It will be apparent to those skilled in the art that the present disclosure is not limited to those mentioned above, and the present disclosure includes other embodiments and variations.

### BRIEF DESCRIPTION OF THE DRAWINGS

The present disclosure will be more apparent from the following detailed description taken in conjunction with the accompanying drawings, in which:

FIG. 1A is a block diagram of a portable terminal according to various embodiments of the present disclosure;

FIG. 1B and FIG. 1C are diagrams illustrating a portable terminal according to various embodiments of the present disclosure;

FIG. 2A, FIG. 2B, FIG. 2C, FIG. 2D, FIG. 2E, FIG. 2F, FIG. 2G, FIG. 2H, FIG. 2I, FIG. 2J, FIG. 2K, FIG. 2L, FIG. 2M, FIG. 2N, FIG. 2O and FIG. 2P are diagrams illustrating examples in which a first process is provided to a user through a portable terminal according to various embodiments of the present disclosure;

FIG. 3 is a flowchart illustrating operations through which the first process is executed in a portable terminal according to various embodiments of the present disclosure;

FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, FIG. 4P and FIG. 4Q are diagrams illustrating various information that a user determines or sets in a second process according to various embodiments of the present disclosure;

FIG. 5A, FIG. 5B, FIG. 5C, FIG. 5D, FIG. 5E, FIG. 5F, FIG. 5G, FIG. 5H, FIG. 5I and FIG. 5J are diagrams illustrating a function or an operation of executing the second process according to various embodiments of the present disclosure;

FIG. 6 is a flowchart illustrating operations through which the second process is executed in a portable terminal according to various embodiments of the present disclosure;

FIG. 7A, FIG. 7B, FIG. 7C, FIG. 7D and FIG. 7E are diagrams illustrating a function or an operation that suspends an image provided to the user in response to an input from the user while the second process is executed according to various embodiments of the present disclosure;

FIG. 8A, FIG. 8B, FIG. 8C, FIG. 8D and FIG. 8E are diagrams illustrating a function or an operation that terminates an image that is provided to the user in response to an input from the user while the second process is executed according to various embodiments of the present disclosure;

FIG. 9A, FIG. 9B, FIG. 9C, FIG. 9D, FIG. 9E, FIG. 9F and FIG. 9G are diagrams illustrating a function or an operation that displays a guidance message indicating the starting and ending of an image provided to the user together, while the second process is executed according to various embodiments of the present disclosure;

FIG. 10A, FIG. 10B, FIG. 10C and FIG. 10D are diagrams illustrating a function or an operation that controls the output settings of an image provided to the user while the second process is executed according to various embodiments of the present disclosure;

FIG. 11 is a block diagram of a wearable device according to various embodiments of the present disclosure;

FIG. 12A, FIG. 12B, FIG. 12C, FIG. 13A, FIG. 13B, FIG. 13C and FIG. 13D are diagrams illustrating a function or an operation that determines the movement of a user based on the movements of the portable terminal and the wearable device detected through a gyro sensor according to various embodiments of the present disclosure;

FIG. 14A, FIG. 14B and FIG. 14C are diagrams illustrating a function or an operation that compares the exercise posture of a user and the exercise posture in an image provided to the user, through a wearable device according to various embodiments of the present disclosure;

FIG. 15 is a flowchart illustrating operations through which the first process is executed through the wearable device and the portable terminal that is connected with the wearable device according to various embodiments of the present disclosure;

FIG. 16A and FIG. 16B are flowcharts illustrating operations through which the second process is executed through the wearable device and the portable terminal that is connected with the wearable device according to various embodiments of the present disclosure;

FIG. 17A, FIG. 17B, FIG. 17C and FIG. 17D are diagrams illustrating a function or an operation that selects a personal trainer of the user in the second process according to various embodiments of the present disclosure; and

FIG. 18A, FIG. 18B and FIG. 18C are diagrams illustrating a function or an operation that manages a user's health care program by a personal trainer selected by the user.

### DETAILED DESCRIPTION

As the present disclosure allows for various changes and numerous embodiments, particular embodiments will be illustrated in the drawings and described in detail. However, the embodiments do not limit the present disclosure to a specific implementation, but should be construed as including all modifications, equivalents, and replacements included in the present disclosure.

Although the terms including an ordinal number such as first, second, etc. can be used for describing various elements, the structural elements are not restricted by the terms. The terms are used merely for the purpose to distinguish an element from the other elements. For example, a first element could be termed a second element, and similarly, a second element could be also termed a first element without departing from the scope of the present disclosure. As used herein, the term “and/or” includes any and all combinations of one or more associated items.

The terms used in this application is for the purpose of describing particular embodiments only and is not intended to limit the disclosure. As used herein, the singular forms are intended to include the plural forms as well, unless the context clearly indicates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof.

Unless defined differently, all terms used herein, which include technical terminologies or scientific terminologies, have the same meaning as that understood by a person skilled in the art to which the present disclosure belongs. It should be interpreted that the terms, which are identical to those defined in general dictionaries, have the meaning identical to that in the context of the related technique. The terms should not be ideally or excessively interpreted as a formal meaning.

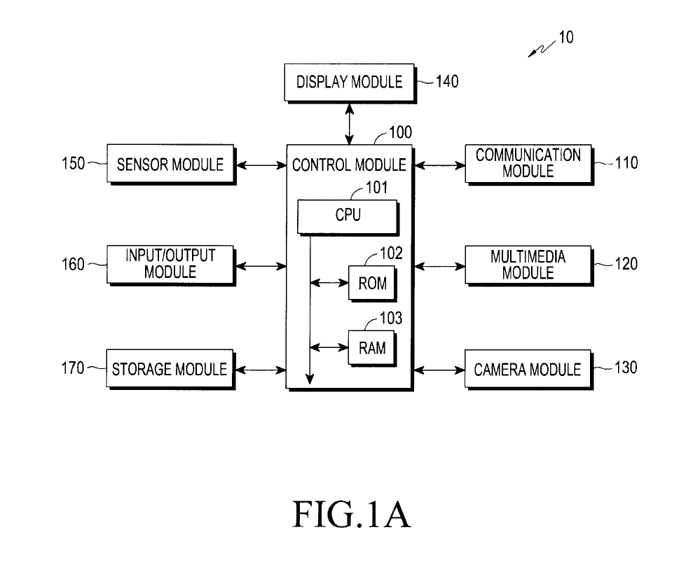

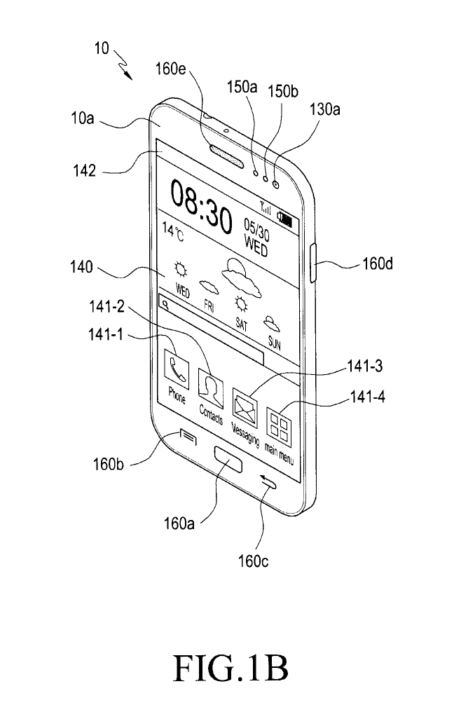

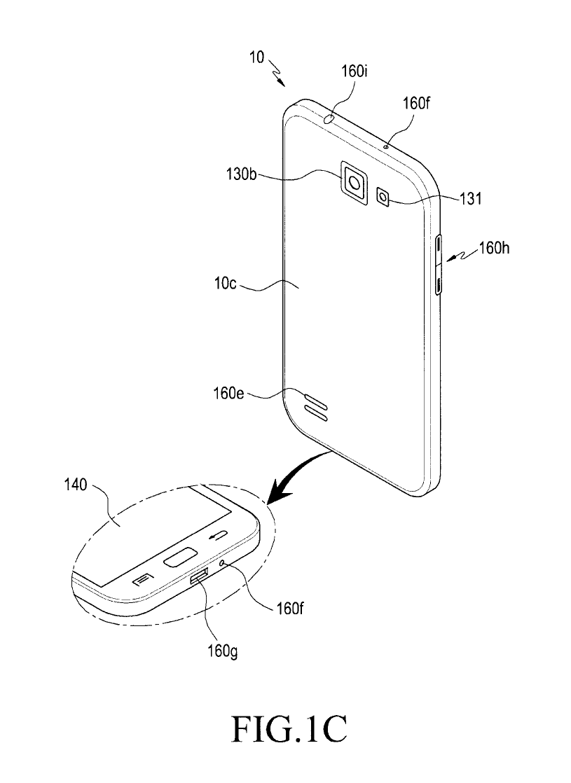

FIG. 1A is a block diagram of a portable terminal 10 according to various embodiments of the present disclosure.

Referring to FIG. 1A, the portable terminal 10, according to various embodiments of the present disclosure, may include a control module 100, a communication module 110, a multimedia module 120, a camera module 130, a display module 140, a sensor module 150, an input/output module 160, and a storage module 170.

The portable terminal 10, according to an embodiment of the present disclosure, may include an electronic device that includes a communication function. For example, the electronic device may include at least one of a smart phone, a tablet personal computer (PC), a mobile phone, a video phone, an e-book reader, a desktop PC, a laptop PC, a netbook computer, a personal digital assistant (PDA), a portable multimedia player (PMP), an MP3 player, a mobile medical device, a camera, a wearable device (e.g., a head-mounted-device (HMD) such as electronic glasses, electronic clothes, an electronic bracelet, an electronic necklace, an electronic appcessory, an electronic tattoo, or a smart watch). Although, for the ease of description, the present disclosure describes a smart phone as an example of the portable terminal 10, it is apparent that the embodiments of the present disclosure may not be limited thereto.

The control module 100 may include, for example, a Central Processing Unit (CPU) 101. Although not illustrated in FIG. 1A, the control module 100 may include one or more of an Application Processor (AP) and a Communication Processor (CP). The control module 100 may execute a calculation or data processing in association with the control and/or communication of at least one other component (for example, the communication module 110, the multimedia module 120, the camera module 130, the display module 140, the sensor module 150, the input/output module 160, and the storage module 170). The control module 100 may include a Read Only Memory (ROM) 102 that stores a control program for controlling the portable terminal 10, and a Random Access Memory (RAM) 103 that is used as a memory space that stores a signal or data input from the outside or stores a task executed in the portable terminal 10. The CPU 101, the ROM 102 and the RAM 103 may be interconnected through internal buses.

The portable terminal 10 may be connected to a network through wired communication or wireless communication using the communication module 110, and may communicate with an external device. The wireless communication may use, for example, at least one of LTE, LTE-A, CDMA, WCDMA, UMTS, WiBro, GSM, and the like, as a cellular communication protocol. The wired communication may include, for example, at least one of a Universal Serial Bus (USB), a High Definition Multimedia Interface (HDMI), Recommended Standard 232 (RS-232), and a Plain Old Telephone Service (POTS). The network 162 may include at least one among various telecommunication networks, such as a computer network (for example, a LAN or a WAN), the Internet, and a telephone network.

The multimedia module 120 may include, for example, a broadcasting communication module, an audio reproduction module, or a video reproduction module. The broadcasting communication module may receive a broadcasting signal (for example, a TV broadcasting signal, a radio broadcasting signal, or a data broadcasting signal) and broadcasting supplementary information (for example, Electric Program Guide (EPS) or Electric Service Guide (ESG)) which is transmitted from a broadcasting station through a broadcasting communication antenna (not shown) under the control of the control module 100. The audio reproduction module may reproduce a stored or received digital audio file (for example, a file of which the file extension is mp3, wma, ogg, or way) under the control of the control module 100. The video reproduction module may reproduce a stored or received digital video file (for example, a file having a file extension of mpeg, mpg, mp4, avi, mov, or mkv) under the control of the control module 100. The video reproduction module may reproduce a digital audio file.

The camera module 130 may include at least one of a first camera 130a and a second camera 130b for photographing a still image or a video under the control of the control module 100. Further, the first camera 130a or the second camera 130b may include a supplementary light source (for example, a flash 131) that provides the amount of light that is utilized for photographing. The first camera 130a may be disposed on the front of the portable terminal 10, and the second camera 130b may be disposed on the back of the portable terminal 10. According to various embodiments of the present disclosure, the first camera 130a and the second camera 130b are disposed to be close to each other, and may photograph a three-dimensional (3D) still image or 3D video.

The display 140 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display module 140 may display various types of contents (for example, text, images, videos, icons, or symbols). The display module 140 may include a touch screen, and may receive, for example, a touch, gesture, proximity, or hovering input using an electronic pen or a user's body part. When the display module 140 is manufactured to be a touch screen, various functions executed by the input/output module 160, which will be described later, or a function of at least a few operations executed by the input/output module 160 may be executed by the display module 140. For the ease of description of the present disclosure, the present specification will describe the case in which the display module 140 is embodied as a touch screen, for the illustrative purpose.

The sensor module 150 may measure a physical quantity or detect (or measure) an operation state of the portable terminal 10, and may convert the measured or detected information to an electrical signal. The sensor module 150, for example, may include at least one of a gesture sensor, a gyro sensor, an atmospheric pressure sensor, a magnetic sensor, an acceleration sensor, a grip sensor, a proximity sensor, a color sensor (for example, a Red, Green, Blue (RGB) sensor), a biometric sensor, a temperature/humidity sensor, an illumination sensor, and a UV sensor. The sensor module 150 may further include a control circuit for controlling at least one sensor included therein.

The input/output interface 160 may serve as an interface that may transmit instructions or data input from a user or another external device to other component(s) of the portable terminal 10. Further, the input/output interface 160 may output instructions or data received from other component(s) of the portable terminal 10 to a user or another external device. The input/output module 160 may include, for example, a plurality of buttons 160a, 160b, 160c, 160d, and 160h, a microphone 160f, a speaker 160e, a vibration motor, a connector 160g, and a keypad.

The storage module 170 may store instructions or data received or generated by the control module 100 or other components (for example, the communication module 110, the multimedia module 120, the camera module 130, the display module 140, the sensor module 150, the input/output module 160, and the storage module 170).

FIGS. 1B and 1C are diagrams illustrating a portable terminal according to various embodiments of the present disclosure.

Referring to FIGS. 1B and 1C, the display module 140 may be disposed in the center of the front side 10a of the portable terminal 10. The display module 140 may be formed to occupy most of the front side 10a of the portable terminal 10. FIG. 1B illustrates an example in which a home screen is displayed in the display module 140. The home screen may indicate a first screen displayed in the display module 140 when the portable terminal 10 is powered on. Also, when the portable terminal 10 includes different screens of various pages, the home screen may indicate the first screen of the screens of the various pages. Short-cut icons 141-1, 141-2, and 141-3 for executing frequently used applications, a shift-to-applications key 141-4, time, weather, or the like may be displayed on the home screen. By selecting the shift-to-applications key 141-4, application icons indicating the applications in the display module 140 may be displayed on a screen. Also, in the top end of the display module 140, a status bar 142 that displays the status of the portable terminal 10, such as the battery charging state, the strength of a received signal, the time, or the like, may be displayed.

In the bottom of the display module 140, a home button 160a, a menu button 160b, and a back button 160c may be displayed.

By selecting the home button 160a, a home screen may be displayed in the display module 140. For example, in the state in which any home screen that is different from the home screen or a menu screen is displayed in the display module 140, when the home button 160a is pressed (or touched), the home screen may be displayed in the display module 140. Also, while applications are executed in the display module 140, when the home button 160a is pressed (or touched), the home screen illustrated in FIG. 1B may be displayed in the display module 140. Also, the home button 160a may be used to display recently used applications or a task manager in the display module 140.

The menu button 160b may provide a connectivity menu that may be used in the display module 140. The connectivity menu may include a widget addition menu, a background switching menu, a search menu, an editing menu, an environment setting menu, or the like. When an application is executed, a connectivity menu connected to the application may be provided.

The back button 160c may display a screen that was executed immediately before a currently executed screen, or may terminate the most recently used application.

In an edge of the front side 10a of the portable terminal 10, the first camera 130a, a sensor module (for example, an illumination sensor 150a and a proximity sensor 150b) may be disposed. In the back side 10c of the portable terminal 10, the second camera 130b, the flash 131, and the speaker 160e may be disposed.

In a lateral side 10b of the portable terminal 10, for example, the power/reset button 160d, the voice adjusting button 160h, the plurality of microphones 160f, and the like may be disposed. Also, in the lateral side of the bottom of the portable terminal 10, a connector 160g may be formed. A plurality of electrodes are formed in the connector 160g, and may be wiredly connected to an external device. In the lateral side of the top of the portable terminal 10, an earphone connecting jack may be formed. An earphone may be inserted into the earphone connecting jack.

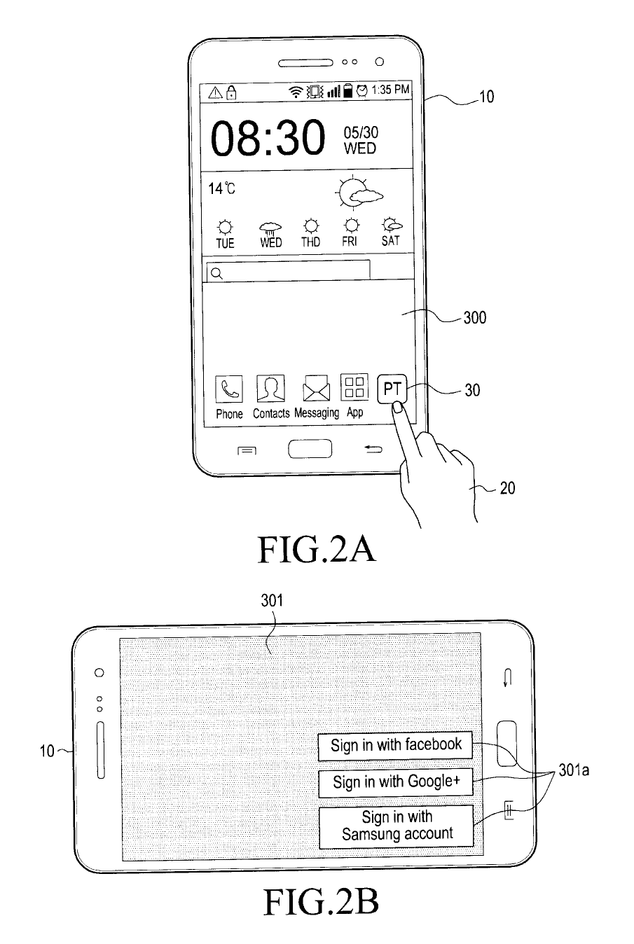

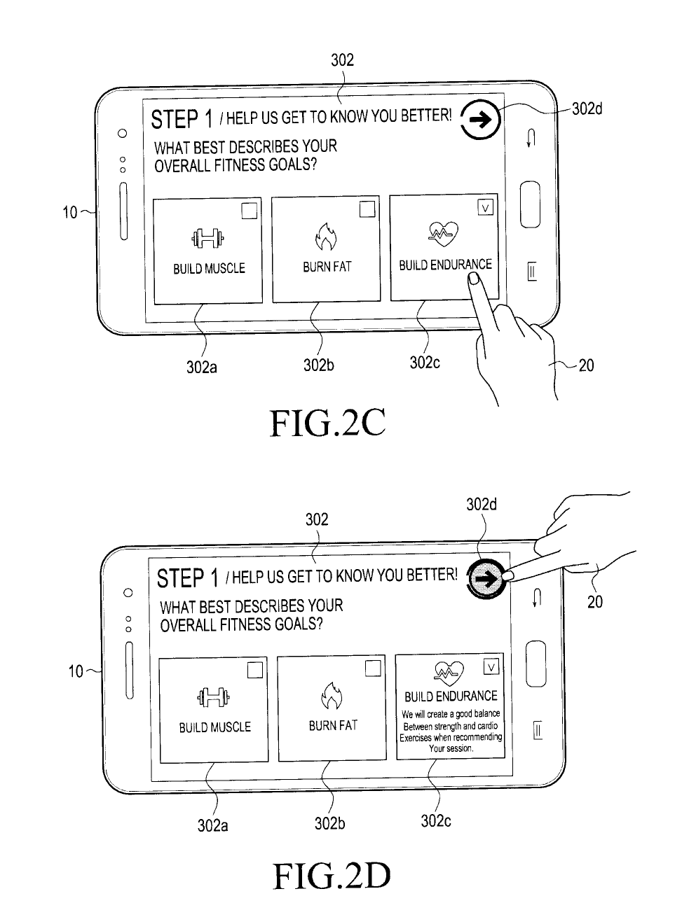

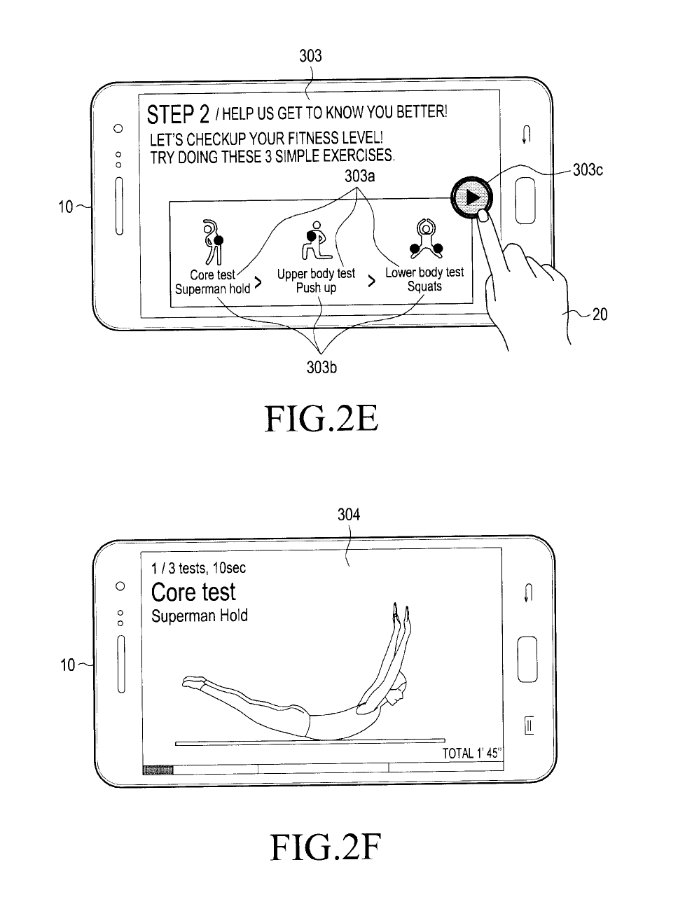

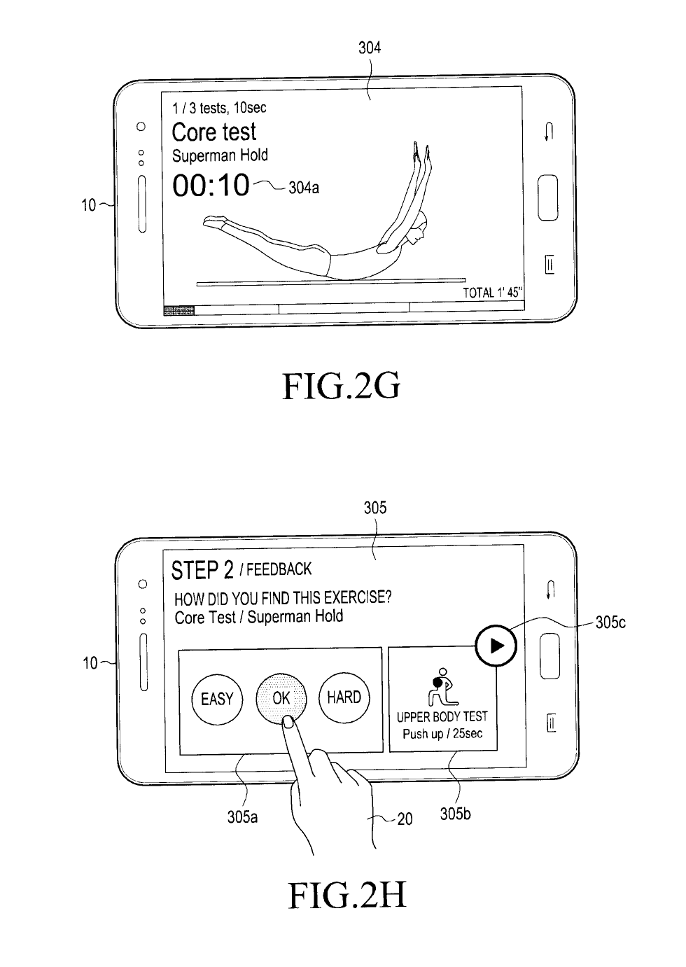

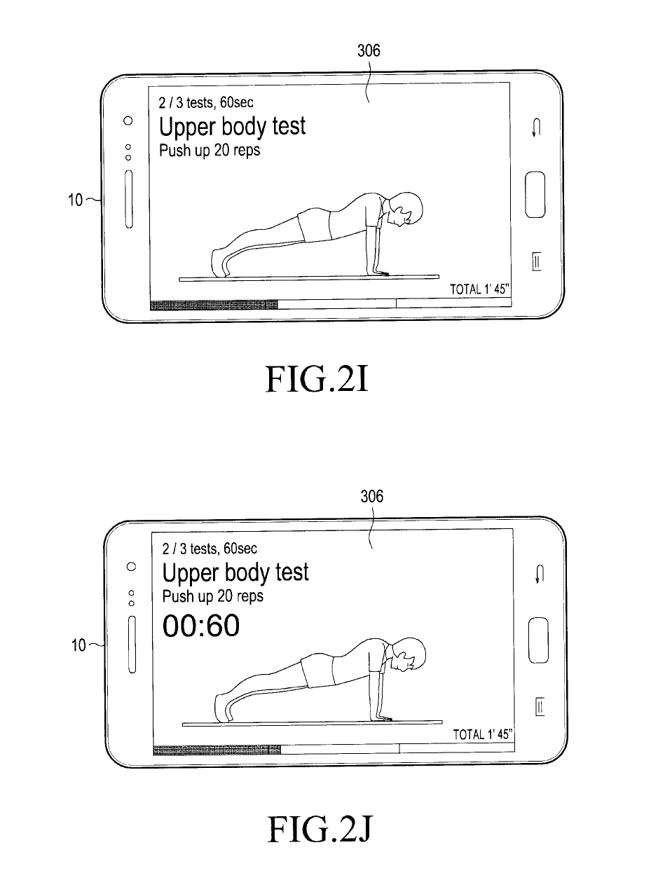

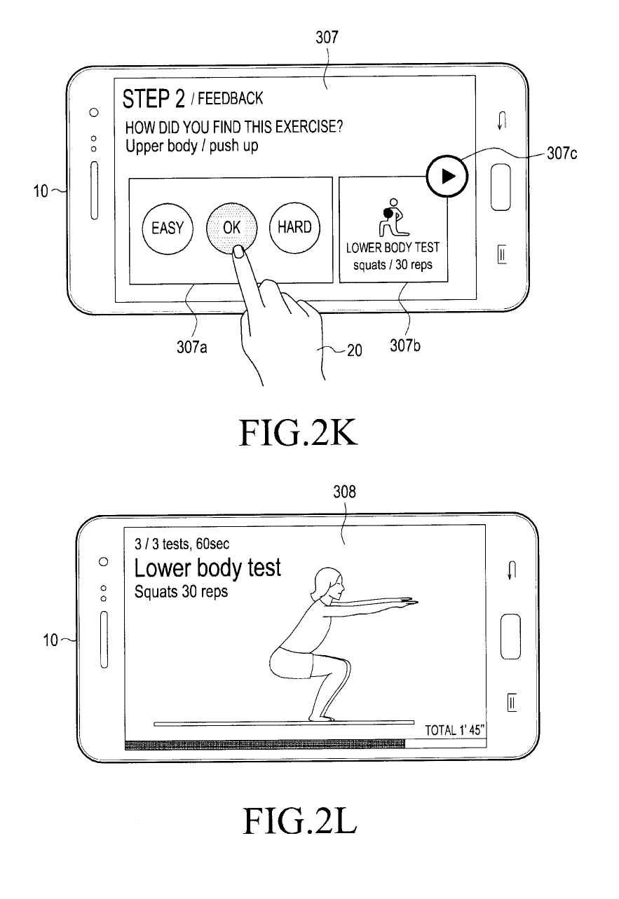

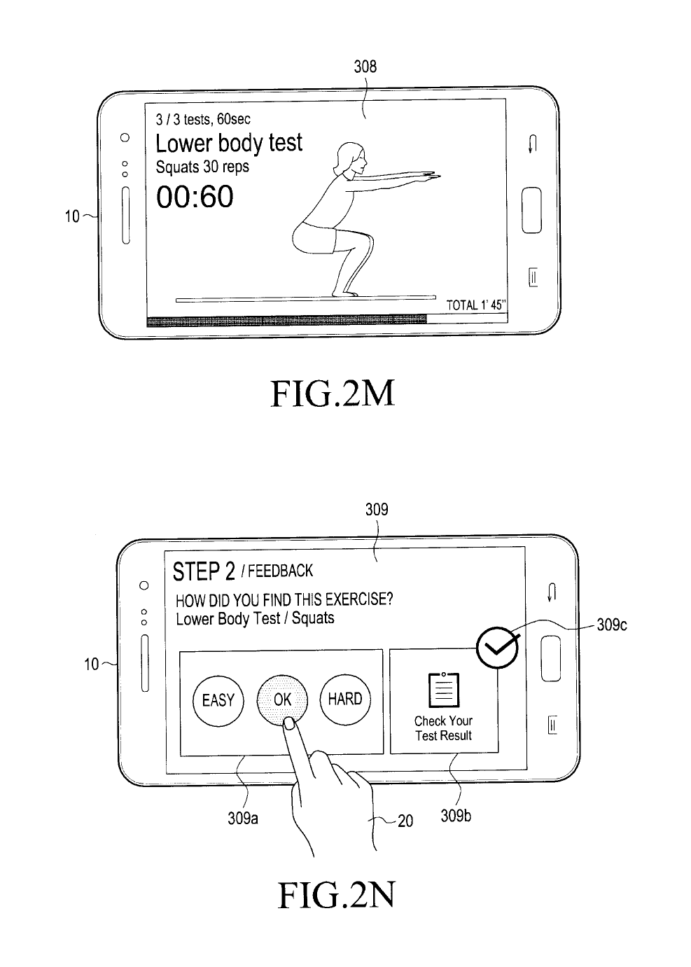

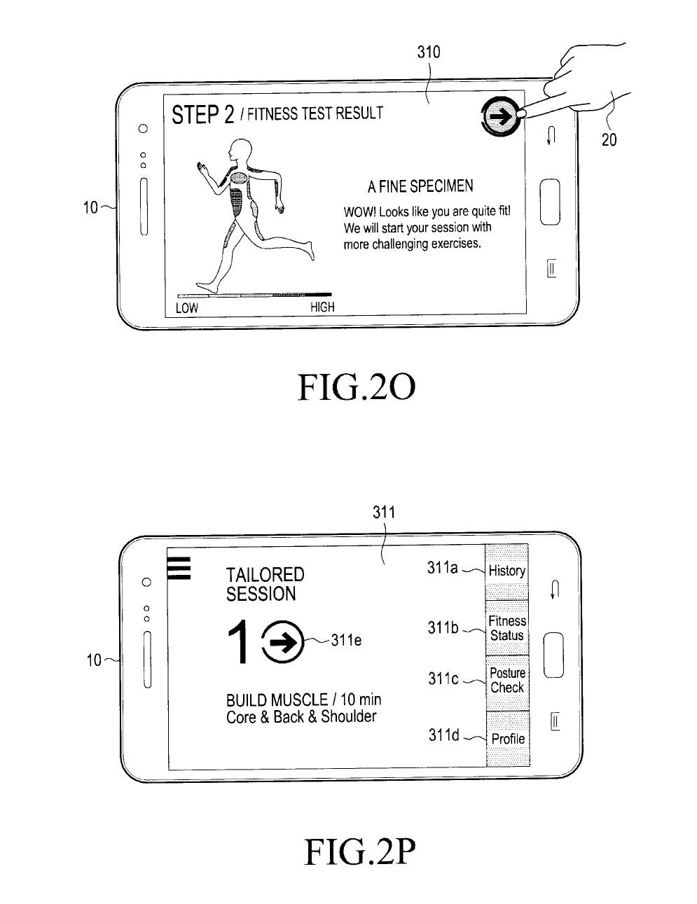

FIGS. 2A to 2P are diagrams illustrating an example in which a first process is executed through the portable terminal according to various embodiments of the present disclosure.

Referring to FIG. 2A, the portable terminal 10 may receive, from a user 20, an input for executing the health care program. The input for executing the health care program may include, for example, selecting an application icon 30 for executing the health care program. The application icon 30 may be displayed in a home screen 300.

The term “health care program” may indicate a program (or contents) that may provide the user 20 with a video (for example, visual guide) showing the exercise posture of a trainer through the portable terminal 10, and may provide the user 20 with an environment where the user 20 exercises in the right posture using the provided video. The health care program may be embodied, for example, in the form of an application that may be executable in the portable terminal 10. Also, the health care program may include, for example, a first process and a second process.

In the present specification, the term “first process” may indicate a process, a function, or an operation of determining the current physical state of the user 20 (for example, muscular endurance, flexibility, or the like of the user 20), in order to provide an exercise motion (for example, push-up, squat, or the like) that is appropriate for the current physical state of the user 20 in the second process. The term “first process” may be interchangeable with various expressions such as “test process”, “exercise capability measuring process,” “physical state test process,” or the like, according to an embodiment of the present disclosure. Also, in the present specification, the term “second process” may indicate a process, an operation, or a function for providing the user 20 with various exercise motions that are determined based on the determined physical state of the user 20, so as to provide an environment where the user 20 exercises. Also, the term “physical state” of the user may include, for example, “exercise capability” of the user 20 and “body type” of the user 20, which are determined based on the muscular strength, muscular endurance, muscle mass, or the like of the user 20. The term “physical state” of the user may be interchangeable with various terms such as “exercise capability”, “body type”, “physical level”, or the like, according to an embodiment of the present disclosure.

Referring to FIG. 2B, when an input for executing the health care program is received from the user 20, the control module 100 may execute a control to display, in the display module 140, and various screens (e.g., icons, menus, or dialogue options) 301a for registering the user 20. Although not illustrated, for the registration, various information associated with the user 20 (for example, an ID, a phone number, or the like in association with the user 20) may be input by the user 20. The term “registration” may be interchangeable with the term “log-in” according to an embodiment of the present disclosure.

Referring to FIG. 2C, after the registration is executed, the control module 100 may proceed with the first process to determine the current physical state of the user 20. FIG. 2C illustrates an initial screen 302 of the first process. The initial screen 302 of the first process may display various icons or images representing types of fitness goals 302a, 302b, and 302c. FIG. 2 illustrates “build muscular strength”, “burn fat”, and “build endurance” as examples of the images 302a, 302b and 302c representing types of fitness goals. However, it should be understood that FIG. 2C describes a mere embodiment of present disclosure, and various goals of the fitness may be additionally included in the initial screen 302 of the first process beyond those explicitly illustrated.

The portable terminal 10 may receive a selection indicating one of the fitness goals from the user 20 as illustrated in FIG. 2C. The fitness goal of the user 20 may be received through a selection input of the user 20 in association with one of the types of the fitness goal 302a, 302b, and 302c. FIG. 2C illustrates the case in which “build endurance” 302c is selected as the fitness goal, as an example. When the portable terminal 10 receives, from the user 20, a selected fitness goal, and receives a selection input associated with a progress icon 302d as illustrated in FIG. 2D, test items 303a (for example, “core test”, “upper body test”, or “lower body test”) may be provided to the user 20 as illustrated in FIG. 2E. Also, at least one test motion 303b (for example, “superman hold”, “push up”, or “squat”) may be included in each test item. Different types of test items may be provided to the user 20, based on at least one of gender, age, and physical conditions (for example, the height, weight, or the like of the user 20). For example, when a push-up motion is provided to the user 20, at least one of the level of difficulty of the push-up motion, a test time, a repeat count may be changed based on whether the user 20 is a male or a female.

The test items correspond to the selected fitness goal of the user 20, and the various types of fitness goals 302a, 302b, and 302c may include identical or different test items. Also, although FIG. 2E illustrates that the test item includes a single test motion, a single test item may include a plurality of test motions. Also, one or more images provided to the user 20 in the first process so as to determine the physical state of the user 20, such as, an image associated with a test item or an “image of test motion”, may be referred to as a “first image”, and one or more images provided to the user 20 in the second process, such as an image associated with the exercise motion or an image associated with a predetermined session, may be referred to as “second image.” Also, according to various embodiments of the present disclosure, one or more images provided to the user 20 in the first process and one or more images provided to the user in the second process may be generally referred to as a “standard image” or a “reference image.”

As illustrated in FIG. 2E, when a selection input associated with a progress icon 303c is received from the user 20 in a test guidance screen 303, the control module 100 may execute a control to execute a test so as to determine the muscular endurance of the user 20, which is selected as the fitness goal of the user 20.

Referring to FIGS. 2F and 2G, as a test motion for determining the muscular endurance of the user 20, a screen image 304 showing a motion associated with “superman hold” may be displayed in the portable terminal 10. The motion associated with the “superman hold” may be played back through, for example, a video, and a residual time 304a of the video may be displayed together in the screen image 304, as illustrated in FIG. 2G. However, the test motion may be displayed as a still image in the portable terminal 10. Also, in the screen image 304, a total time of the first process (for example, 1 minute 45 seconds) may be displayed together. Also, a test item and/or a test type (for example, “core test” and/or “superman hold”) are displayed together in the screen image 304.

Referring to FIG. 2H, when any one test motion is terminated, the control module 100 may execute a control to display a screen (e.g., image) 305 in the portable terminal 10 so as to receive feedback with respect to the executed test motion (for example, “superman hold”) from the user 20. When a plurality of test motions are executed, the control module 100 may execute a control to receive the feedback from the user 20 every time that each test motion is terminated. According to various embodiments of the present disclosure, although a plurality of test motions are executed, the control module 100 may execute a control to display a screen for receiving the feedback from the user 20 when a single test item is terminated.

The control module may execute a control to display, on the screen 305 for receiving the feedback, a user interface (UI) object or image 305a may be displayed for receiving selection of a level of difficulty that the user 20 feels in association with the executed test motion and a UI object or image 305b that indicates a next test motion to be executed (or a subsequent test item), begun when the indicator 305c is selected. FIG. 2H illustrates an example in which the portable terminal 10 receives, from the user 20, feedback indicating that the level of difficulty is appropriate (for example, an “OK” icon is selected). The control module 100 may determine the physical state of the user based on the feedback provided from the user 20, and may execute a control to provide, based on the determined physical state, the user 20 with various exercise motions appropriate for the physical state of the user 20 in the second process.

Also, although not illustrated, the screen 305 for receiving the feedback of the user 20 may include various UIs for directly receiving, from the user 20, at least one of the number of times that the user 20 executes the test motion, an amount of time that the user 20 actually executes the test motion, the gender of the user 20, and various pieces of personal health information of the user 20 (for example, the height, age, weight and/or blood pressure and the like of the user 20). The execution of the test motion may be monitored to determine whether the exercise motion executed by the user 20 is sufficiently identical to an reference image (for example, the image of screen 304) provided through the portable terminal 10 or to be identical within a predetermined error range. The portable terminal may thus determined a number of times that the test motion is executed “accurately” or “preferably,” meaning the motion generated by the user passing a sufficient threshold of likeness with the displayed test motion. The portable terminal may discount user motions that do not sufficiently match the test motion. Therefore, an actual count of the user's executed motions may differ from a “valid count” indicating a number of times the user executed the motion with sufficiently proper range, form, posture, and other such details that may be used to gauge the accuracy of the user's executed motions.

A mapping table for determining the physical state (or physical level) of the user 20 based on the feedback input from the user 20 may be stored in the storage module 170. The physical state of the user may be determined by a mapping table, which is illustrated in Table 1 and Table 2. Table 1 provided below is illustrated as an example of a mapping table for determining the physical state of the user 20 based on an input level of difficulty experienced, when the level of difficulty that the user 20 experiences (for example, “easy,” “OK,” “hard”) is input in association with each test motion or each test item when the test motion or the test item is terminated. Table 2 provided below is illustrated as an example of a mapping table for determining the physical state of the user 20 based on various input information when information associated with the gender of the user 20, a valid time and/or a valid count is input from the user 20 instead of the level of difficulty experienced. The various items included in the mapping table may be subdivided and may be used for determining the physical state of the user 20.

Table 1 and Table 2 provided below are merely examples of the mapping table, and the items and the types (for example, high, medium, and low) of the physical state of the user 20 included in the mapping table may variously change. Although, for the ease of description, the examples of the mapping table are described by distinguishing Table 1 and Table 2 for ease of description, the component elements included in Table 1 and Table 2 may be applied together to determine the physical state of the user 20.

TABLE 1

| Gender | Result of feedback | Physical state |
|---|---|---|
| Male | First test motion: “easy” | High |
| | Second test motion: “easy” | |
| | Third test motion: “easy” | |
| | First test motion: “easy” | Medium |
| | Second test motion: “OK” | |
| | Third test motion: “hard” | |
| | First test motion: “hard” | Low |
| | Second test motion: “hard” | |
| | Third test motion: “OK” | |
| Female | First test motion: “easy” | High |
| | Second test motion: “easy” | |
| | Third test motion: “easy” | |
| | First test motion: “easy” | Medium |
| | Second test motion: “OK” | |
| | Third test motion: “hard” | |
| | First test motion: “hard” | Low |
| | Second test motion: “hard” | |
| | Third test motion: “OK” | |

TABLE 2

| | | | Number of | | Physical |
|---|---|---|---|---|---|
| Gender | Test item | Test motion | valid times | Valid time | state |
| Male | Upper body | Push-up | 0~19 times | 1 min. | Low |
| | | | 20~25 times | | Medium |
| | | | 26 or more | | High |
| | | | times | | |
| | Lower body | Squat | 0~49 times | 1 min. | Low |
| | | | 50~60 times | | Medium |
| | | | 61 or more | | High |
| | | | times | | |
| Female | Upper body | Push-up | 0~11 times | 1 min. | Low |
| | | (kneeling | 12~16 times | | Medium |
| | | push up) | 17 or more | | High |
| | | | times | | |
| | Lower body | squat | 0~44 times | 1 min. | Low |
| | | | 45~55 times | | Medium |
| | | | 56 or more | | High |
| | | | times | | |

In the case in which the component elements included in Table 1 and Table 2 are applied together, the level of difficulty experienced (for example, “easy,” “OK,” “hard”), which is defined in Table 1, may be indirectly determined, through the control module 100, based on the information associated with the valid count and valid time which are input from the user 20. That is, when the user 20 is a male, and the input valid count is 22 and the valid time is 1 minute, the level of difficulty that the user 20 experiences (that is, feedback) may be determined to be “OK,” through the control module 100.

The control module 100 may determine various exercise motions provided to the user 20 in the second process, based on the determined physical state of the user 20, as described below. Information associated with various exercise motions that are determined based on the physical state of the user 20 may be stored in the storage module 170. The control module 100 may provide the user 20 with an image that is associated with the exercise motions based on the information associated with the stored various exercise motions. The image associated with the exercise motions may be stored in the storage module 170, or may be received from another external device (for example, a telecommunication firm server) that is connected to the portable terminal 10 over wired/wireless communication, and the image may be provided to the user 20.

Referring to FIGS. 2I to 2K, the control module 100 may execute a control to reproduce a video 306 associated with a push-up motion as another test motion, including indication of a residual time, input of exercise difficulty screen 307a, a display of the next exercise 307b, and a selectable image or icon 307c for advancing to the next exercise. With respect to FIGS. 2I to 2K, the descriptions of FIGS. 2F to 2G are applicable and will be omitted for the sake of brevity.

Similarly, referring to FIGS. 2L to 2M, the control module 100 may execute a control to reproduce a video 308 associated with a squat motion as another test motion. Again, the descriptions of FIGS. 2F to 2G are applicable and thus, a detailed description is omitted for the sake of brevity.

Referring to FIG. 2N, the portable terminal 10 may receive feedback with respect to an executed test motion from the user 20, and may execute a control to display a first process completion screen 309 including a UI 309b for displaying a test result as the first process is terminated. Again, input of exercise difficulty is facilitated via screen 309a. When a request for determining the test result (for example, selecting a progress icon 307c) is input from the user 20, the control module 100 may execute a control to display a screen 310 that displays the test result in the portable terminal 10, as illustrated in FIG. 2O. The test result may be determined based on the feedback (for example, the level of difficulty that the user 20 experiences) input from the user 20. An icon 309c may be displayed, selectable to complete the currently screen of the exercise program.

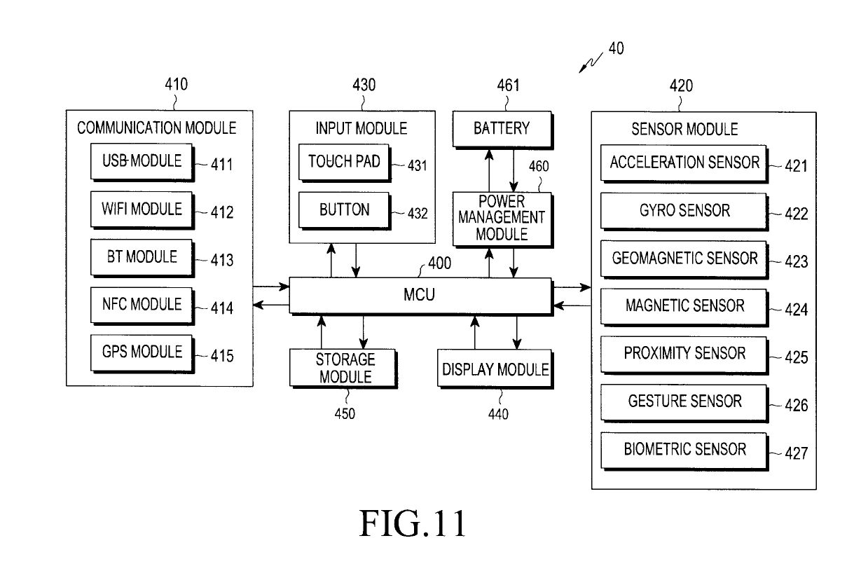

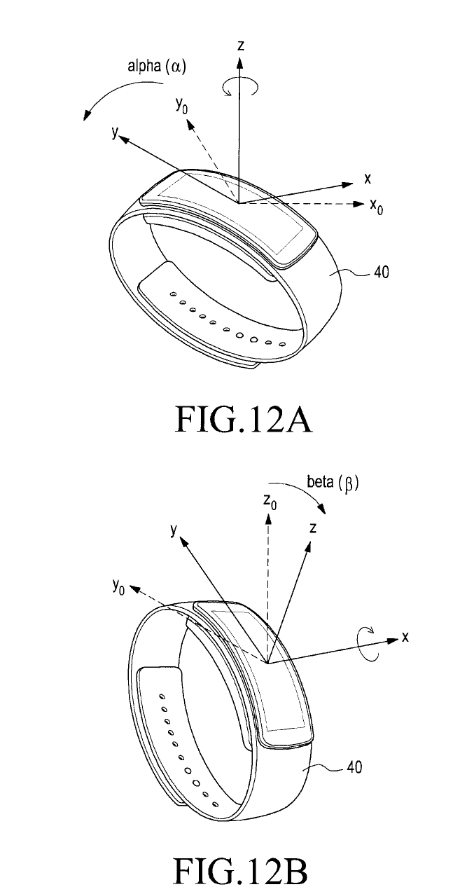

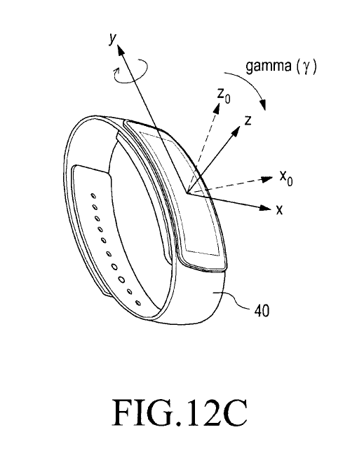

However, according to various embodiments of the present disclosure, the feedback of the user 20 (for example, a level of difficulty experienced, a valid time and/or a valid count, and the like) may be automatically obtained by the portable terminal 10 through a wearable device 40 (as seen in FIGS. 12A-12C) that is worn on a body part of the user 20, as opposed to being directly input by the user 20 into the portable terminal 10. For example, information associated with a movement of the user 20, which is detected by the wearable device 40 that is worn on a body part of the user 20 (for example, α, β, and γ values), is provided from the wearable device 40, and the feedback in association with the test motion of the user 20 may be determined (or decided) based on the provided information associated with the movement of the user 20. In association with a function or an operation of the control module 100 that determines the physical state of the user 20 based on the information associated with the movement of the user 20 after the information associated with the movement of the user is provided to the portable terminal 10, the descriptions in association with Table 1 and Table 2 may be equally applied. In association with the wearable device 40 and a function or an operation of the wearable device 40 that obtains the information associated with the movement of the user 20, the descriptions to be described with reference to FIGS. 11 to 14C will be equally applied.

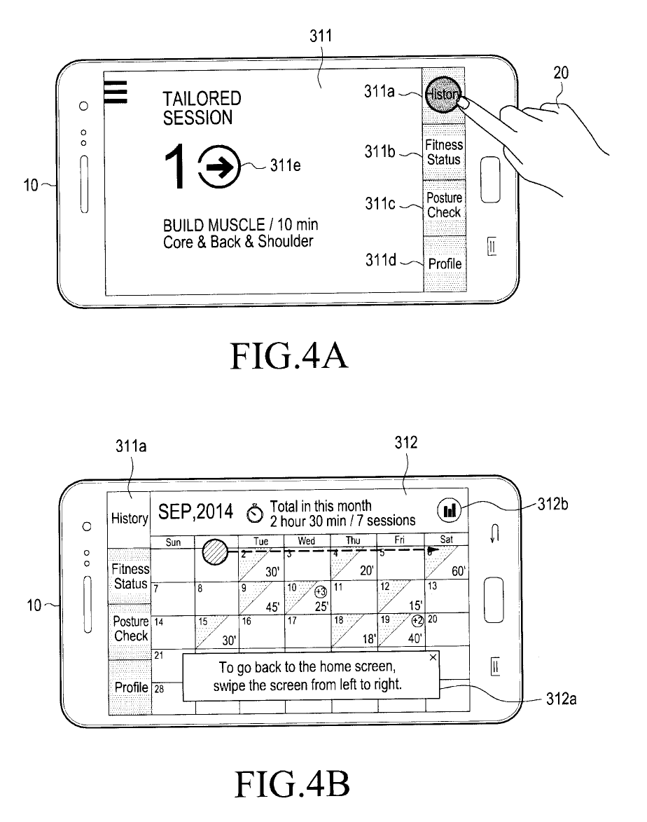

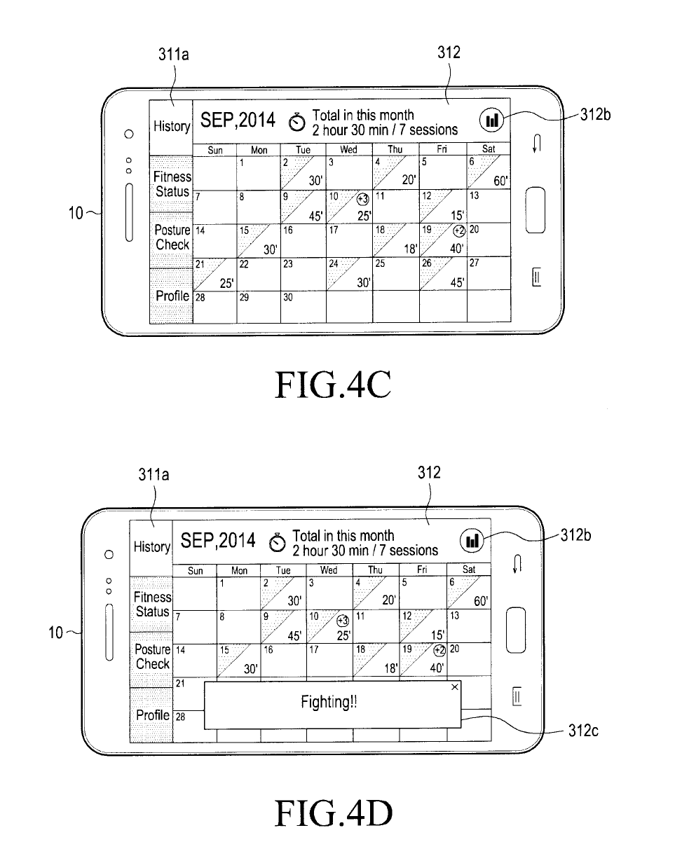

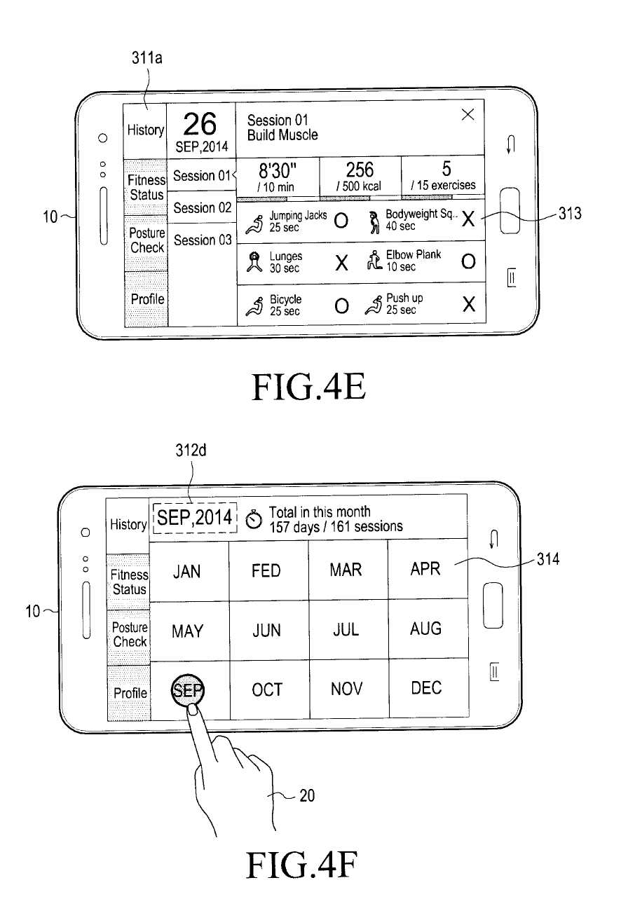

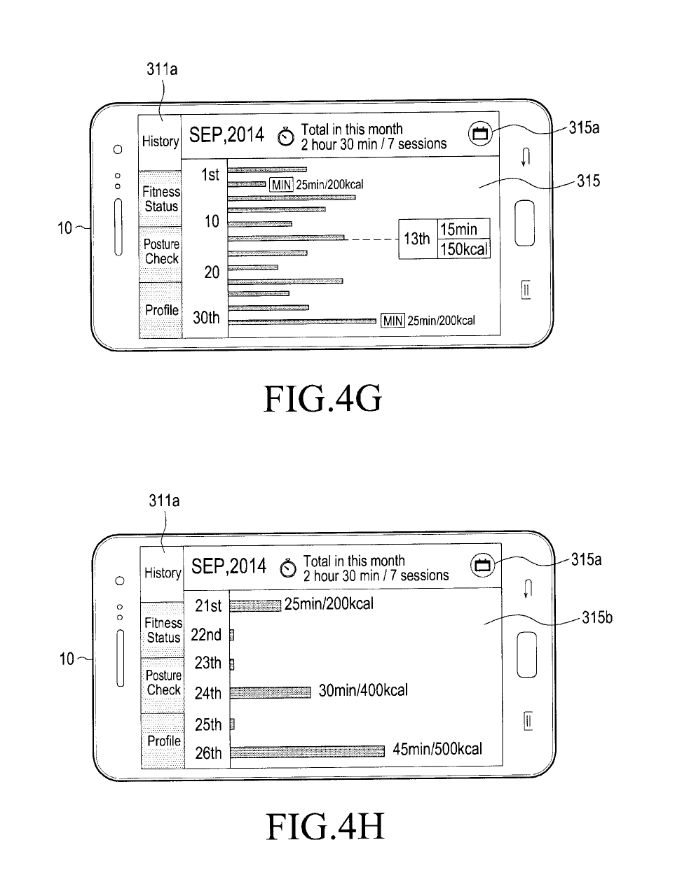

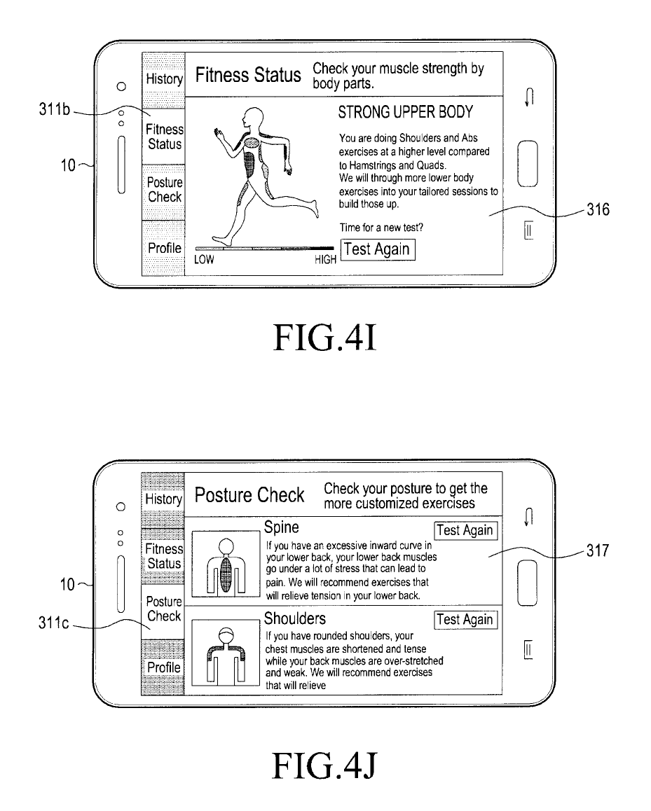

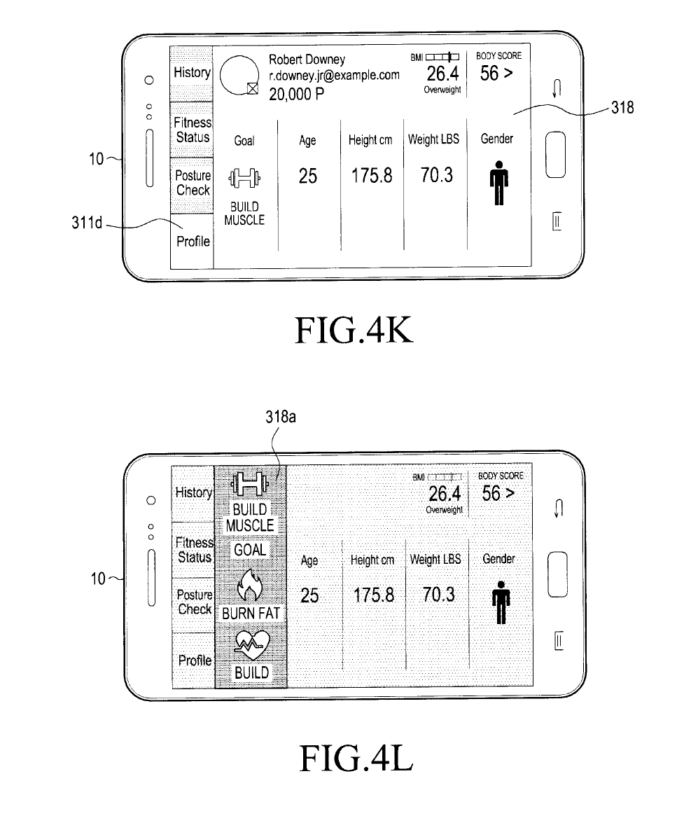

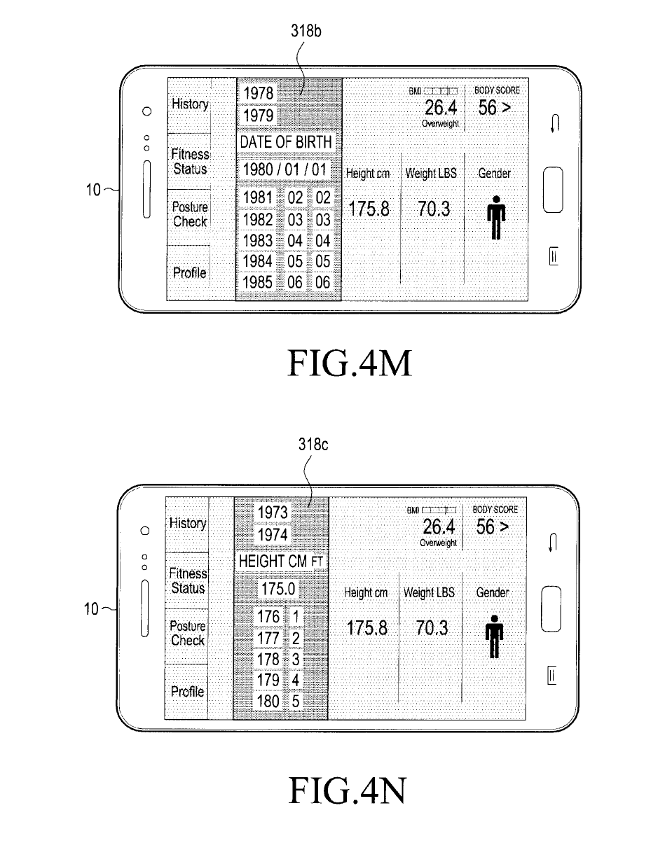

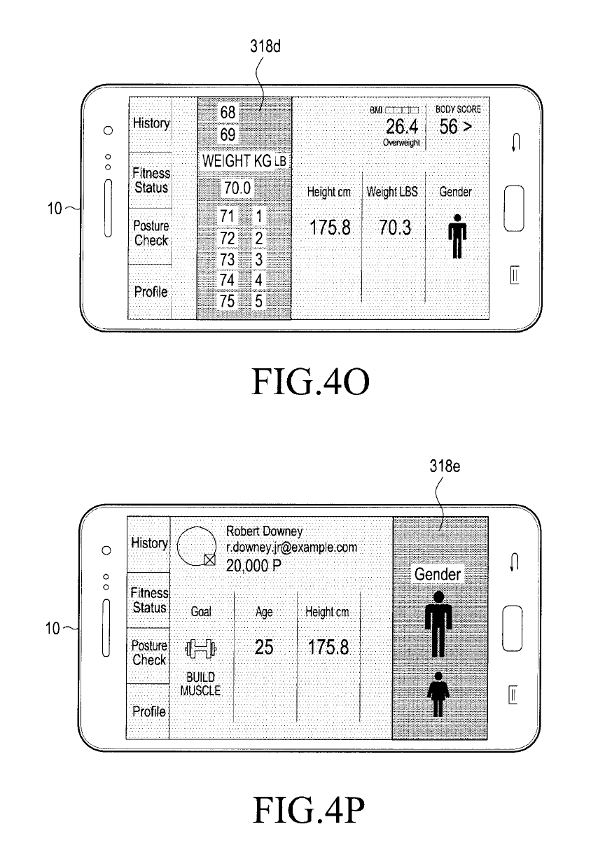

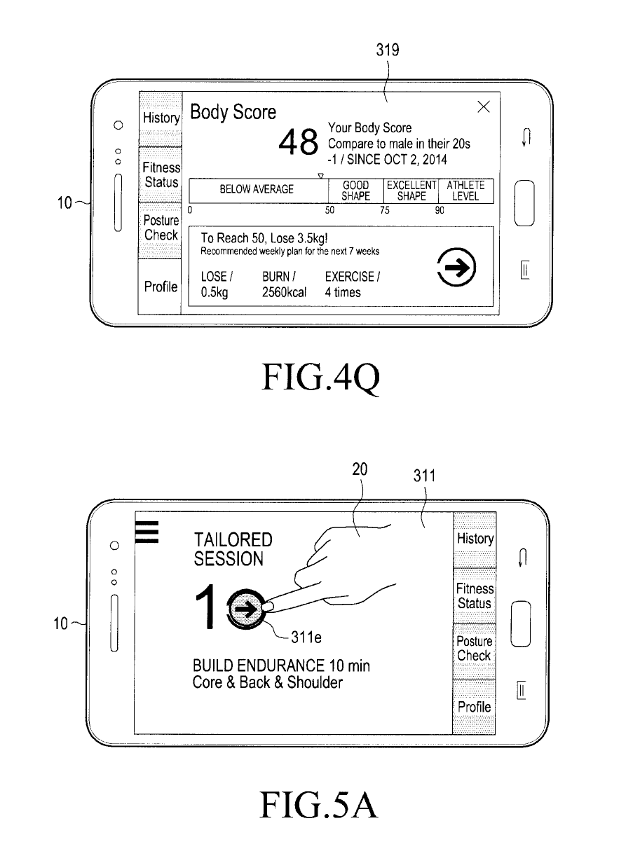

As illustrated in FIG. 2O, when the control module 100 is requested by the user to proceed with a subsequent step, the control module 100 may execute a control to display an initial screen 311 of the second process based on the result of the first process, as illustrated in FIG. 2P. Referring to FIG. 2P, the initial screen 311 may include various menu icons 311a, 311b, 311c, and 311d, and a progress icon 311e for executing a subsequent step. The menus 311a, 311b, 311c, and 311d will be described further below with respect to FIG. 4A.

Although the descriptions in association with FIGS. 2A to 2P illustrate that the test items are three types, it is understood these examples are provided for illustrative purposes, and that the actual exercise types and the number of the test items and test motions included may be variously modified.

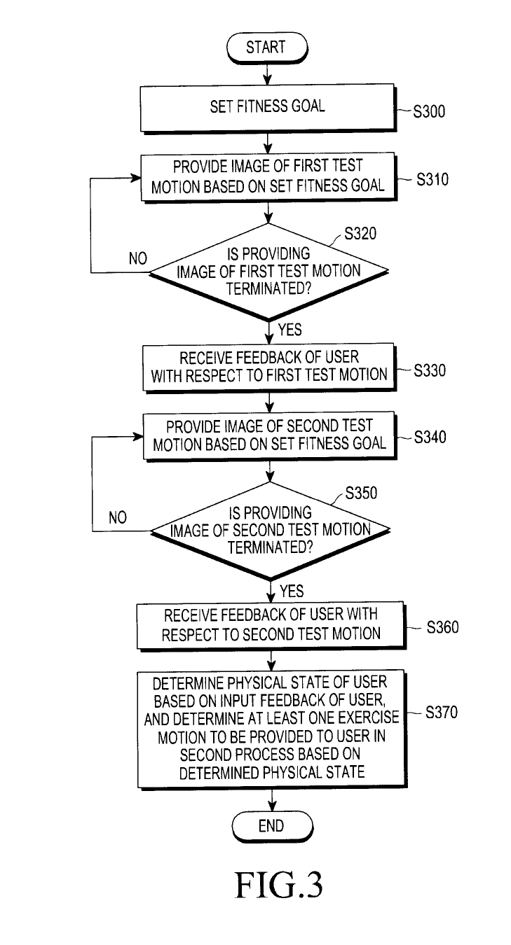

FIG. 3 is a flowchart illustrating operations through which a first process is executed in the portable terminal 10 according to various embodiments of the present disclosure.

Referring to FIG. 3, a controlling method of the portable terminal 10, according to various embodiments of the present disclosure, may include operation S300 in which the portable terminal 10 sets a fitness goal. Setting the fitness goal may be executed by receiving selection information associated with the fitness goal from the user 20. Also, the portable terminal 10 may include operation S310 to provide the user 20 with an image of a first test motion (for example, “superman hold”) based on a type of the received fitness goal. After operation S310, the portable terminal 10 may include operation S320 to determine whether providing the image of the first test motion is terminated. When providing the first test motion is terminated, the portable terminal 10 may include operation S330, which receives the feedback of the user 20 with respect to the first test motion from the user 20. When the feedback with respect to the first test motion is input by the user 20, the portable terminal 10 may include operation S340, which provides an image of a second test motion (for example, “push-up”) in response to a request from the user 20. After operation S340, the portable terminal 10 may include operation S350, which determines whether providing the image of the second test motion is terminated. When providing the second test motion is terminated, the portable terminal 10 may include operation S360, which receives the feedback of the user 20 with respect to the second test motion. When the feedback with respect to the second test motion is input from the user 20, the portable terminal 10 may include operation S370, which determines the current physical state of the user 20 based on the feedback of the user 20, which is input through operations S330 and S360, and determines at least one exercise motion to be provided to the user 20 in a second process. According to various embodiments of the present disclosure in association with FIG. 3, the “first test motion” and the “second test motion” may be executed by being replaced with a “first test item” and a “second test item.” Also, the number of test motions (or test items) described in FIG. 3 is merely described for the illustrative purpose and thus, the number of test motions (or test items) provided to the user 20 may variously change. In addition, in association with the controlling method of the portable terminal 10, according to various embodiments of the present disclosure of FIG. 3, the descriptions of FIGS. 2A to 2P are equally applied.

FIGS. 4A to 4Q are diagrams illustrating various information that a user determines or sets in a second process according to various embodiments of the present disclosure.

Referring to FIGS. 4A to 4H, the user 20 may determine an exercise history of the user 20. As illustrated in FIG. 4A, when the portable terminal 10 receives, from the user 20, a request for providing the exercise history in screen 311, the portable terminal 10 may provide the user 20 with an exercise history screen 312 of the user 20, for example, in a form of a calendar, as shown in FIG. 4C. The request for providing the exercise history may be executed through selecting the history menu 311a. As the exercise history information of the user 20, FIG. 4C illustrates a total amount of time spent exercising in a predetermined month, a time spent exercising in a predetermined day, the total number of sessions executed in a predetermined month, or the like. The exercise history is provided to the user 20 for the first time, the control module 100 may execute a control to display a guidance message 312a designated in advance in association with instructions, as illustrated in FIG. 4B. Also, as illustrated in FIG. 4D, a guidance message 312c that is designated in advance may be displayed in the form of a pop-up, together with the exercise history screen 312. The guidance message 312c may include, for example, an encouraging message for the user 20.

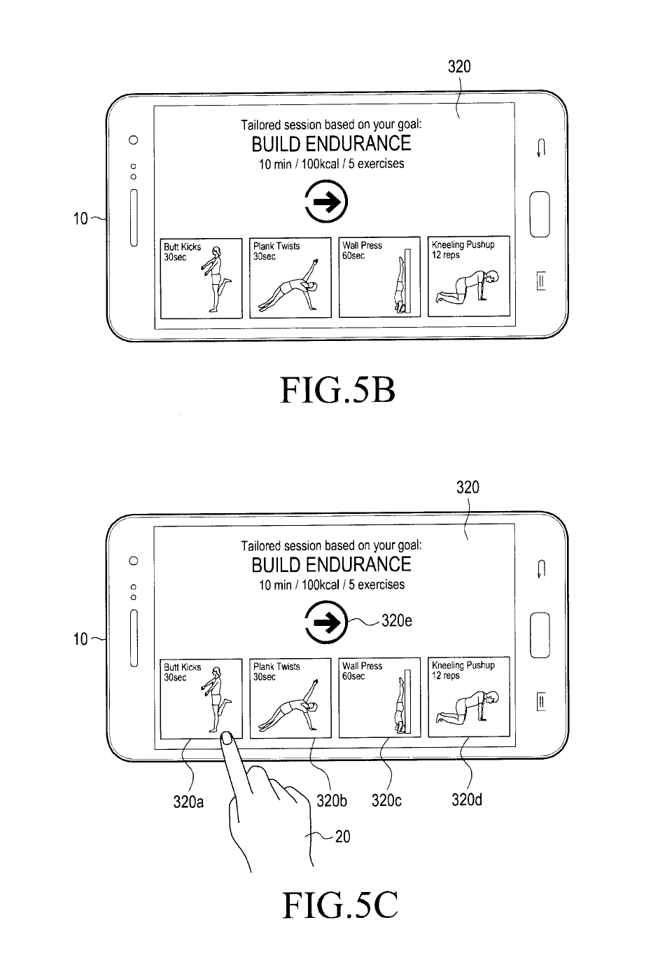

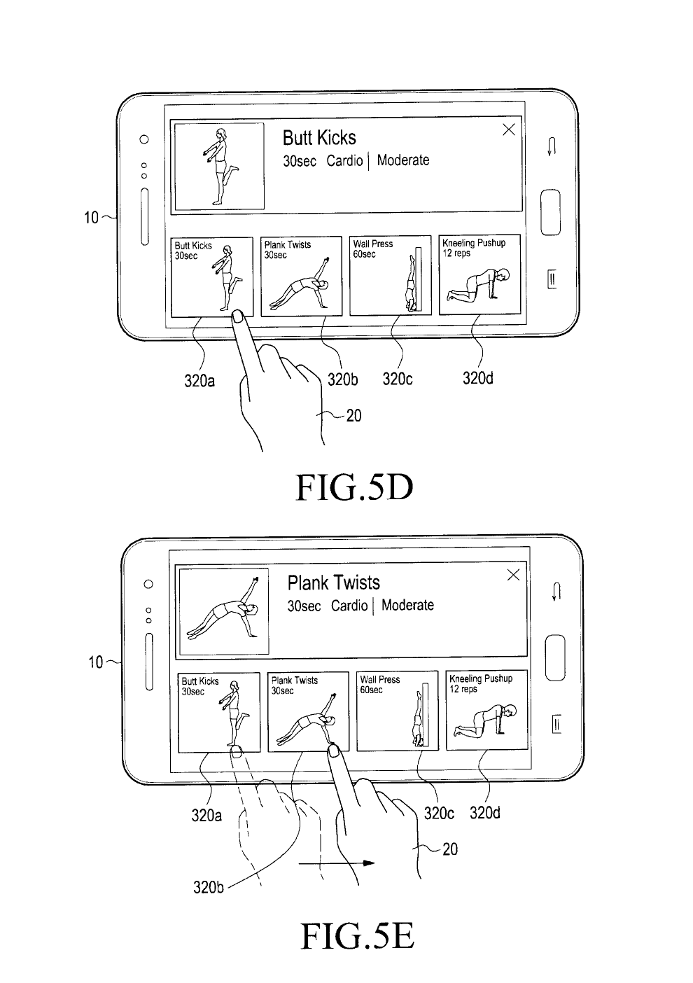

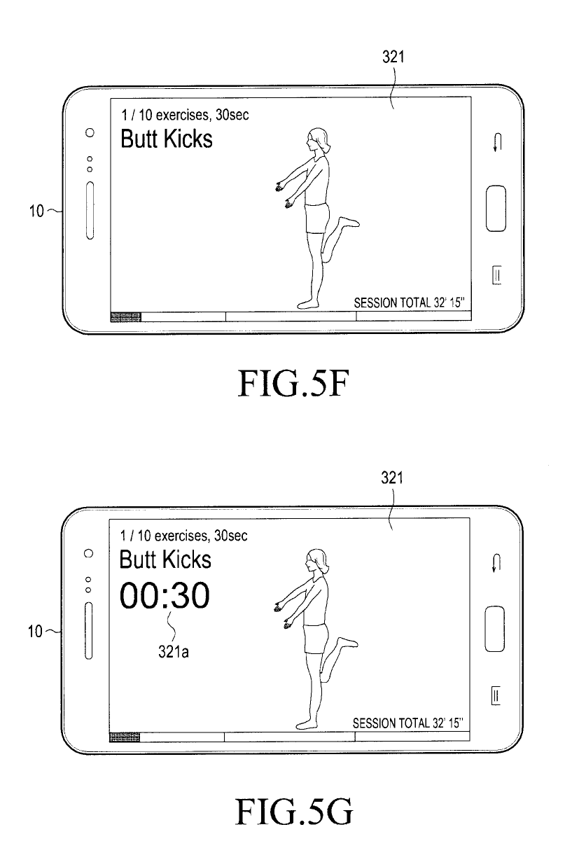

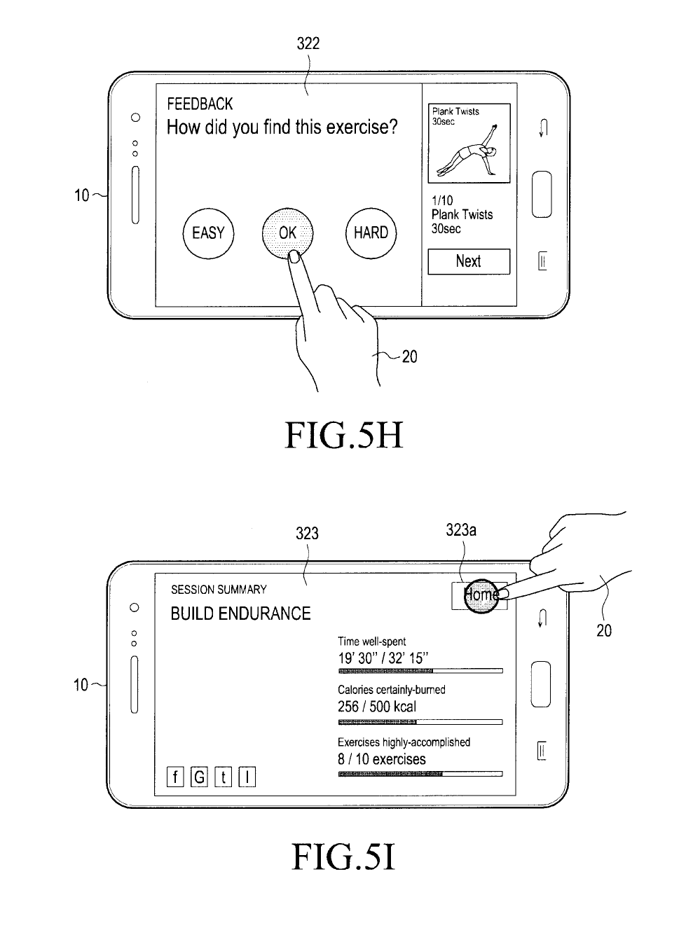

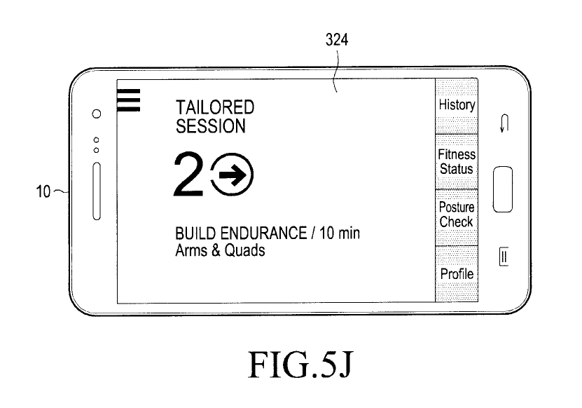

In the present specifications, the term “session” may indicate a set of at least one “exercise motion” (for example, “butt Kicks” 320a and “kneeling push up” 320d) provided to the user 20 in the second process. At least one exercise motion included in a single session may be related to one another in association with a body part of the user 20. That is, various exercise motions 320a, 320b, 320c, and 320d illustrated in FIG. 5B are exercise motions for building or developing the core, back, and shoulder muscles, and are related to one another, and thus, may be included in one session.

Referring to FIG. 4E, when a predetermined date (for example, Sep. 26, 2014) is selected by the user 20, exercise history information 313 associated with the selected date is provided to the user 20. The history information 313 associated with the predetermined date may include, for example, the number of sessions executed, a time spent exercising, a quantity of calories burned, the number of exercise motions executed, whether the goal is achieved in association with each exercise motion, or the like.

Referring to FIGS. 4F to 4H, the control module 100 may execute a control to display, to the user 20, a screen 315 and 315b through which exercise history information of a predetermined month is determined, in response to a request from the user 20. For example, in the state illustrated in FIG. 4C, when a selection input of the user 20 is received in association with an area 312d where the predetermined month is displayed, the control module 100 may display a screen 314 showing information arranged for each month. As illustrated in FIG. 4F, when a selection input associated with a predetermined month is received in the screen 314, the control module 100 may determine the exercise history of the selected month, for example, in the form of a graph, as illustrated in FIG. 4G. In this instance, when a switch icon 315a is selected, the control module 100 may execute a control to switch the existing screen into a screen of FIG. 4C, and may display the same. In the same manner, when a switch icon 312b is selected in the screen illustrated in FIG. 4C, the control module 100 may execute a control to switch the existing screen into a screen of FIG. 4G, and may display the same. When a screen enlarging gesture (for example, pinch zoom in) is received from the user 20, the control module 100 may execute a control to display a screen 315b including more detailed history information.

Referring to FIG. 4I, when the control module 100 receives a request for determining the physical state of the user 20 (for example, receives selection information associated with a menu icon 311b), the control module 100 may execute a control to display a screen 316 containing information associated with the physical state of the user 20, which is determined through the first process, as illustrated in FIG. 4I.

Referring to FIG. 4J, when the control module 100 receives a request for determining the body type of the user 20 (for example, receives a selection input associated with a menu icon 311c), the control module 100 may execute a control to display a screen 317 containing information associated with the body type of the user 20, as illustrated in FIG. 4J. The information associated with the body type of the user 20 may be provided from an external device that is capable of measuring the body type of the user 20.

Referring to FIGS. 4K to 4Q, the control module 100 may receive the physical information of the user 20, may set the profile of the user 20, and may provide the same to the user 20. As illustrated in FIG. 4K, when a request for inputting a profile is received from the user 20 (for example, a selection input in association with a menu icon 311d is received), a screen 318 containing the profile of the user 20 stored in advance may be displayed.

When a request for correcting the profile is received from the user 20, the control module 100 may execute a control to display a screen 318a (FIG. 4L), 318b (FIG. 4M), 318c (FIG. 4N), 318d (FIG. 4O), or 318e (FIG. 4P) for correcting the profile of the user 20. The request for correcting the profile may be executed through, for example, a touch input with respect to each item included in the screen 318. When a request for changing the profile of the user 20 (for example, a drag input or the like) is received in the screen 318a 318b, 318c, 318d, or 318e for correcting the profile, the control module 100 may execute a control to change the profile of the user 20 and store the same in response to the request. Also, as illustrated in FIG. 4Q, the control module 100 may execute a control to display a screen 319 that quantifies (or scores) the physical state of the user 20, based on the information associated with the physical state of the user 20, which is stored in the storage module 170, in response to the request of the user.

FIGS. 5A to 5J are diagrams illustrating functions or operations through which the second process is executed according to various embodiments of the present disclosure.

Referring to FIG. 5A, when the user 20 selects the progress icon 311e on the initial screen 311 of the second process, the control module 100 may execute a control to display a screen 320 containing various exercise motions 320a to 320d, as seen in FIG. 5C, determined based on the physical state of the user 20, which is determined through the selected fitness goal and the first process, as illustrated in FIG. 5B. The number of exercise motions 320a to 320d provided to the user 20 may be determined based on the determined physical state of the user 20. Also, the control module 100 may provide the user 20 with a larger number in association with the number of exercise motions for developing a slightly weaker part, than is provided for other parts of the body of the user 20, based on the determined physical state of the user 20. For example, when it is determined that the shoulders are weaker than other parts of the body based on the determined physical state of the user 20, the control module 100 may execute a control to provide the user 20 with a larger number in association with the number of exercise motions for developing the shoulders than is provided for other exercise motions in a first session (a session for developing the shoulder). Also, in association with the exercise motions for developing the shoulders of the user 20, the control module 100 may execute a control so that motions that are easier than other exercise motions for developing other parts are included.

Referring to FIGS. 5C and 5D, when a request for providing information associated with the exercise motions 320a, 320b, 320c and 320d is received from the user 20 (for example, a long touch on one of the exercise motions), the control module 100 may execute a control to display information associated with the selected exercise motion (for example, “Butt kicks” 320a). The information associated with the exercise motion 320a may include, for example, a performance time of the exercise motion 320a, the level of difficulty of the exercise motion, the main parts to be developed through the exercise motion 320a, and the like. The information associated with the exercise motion may be provided to the user 20, for example, in a form of a pop-up window. Referring to FIG. 5E, when a request (for example, a drag input or a touch input) for providing information associated with another exercise motion (for example, exercise motion 320b) is received while one exercise motion 320a selected by the user is provided in the form of a pop-up window, the control module 100 may not terminate the pop-up window and may execute a control to display the information associated with the other exercise motion (for example, the exercise motion 320b) in the pop-up window.

The control module 100 may execute a control to display a video 321 in association with an exercise motion (for example, the “Butt kicks”) as illustrated in FIG. 5F, when a request for beginning the second process (for example, selecting a progress icon 320e, as seen in FIG. 5C) is received from the user 20. While the video 321 is reproduced, a residual time 321a of the video 321 may be displayed together as illustrated in FIG. 5G. The user 20 may exercise with reference to the reproduced video 321. However, according to various embodiments of the present disclosure, the video 321 may be replaced with a still image, and may be provided to the user 20. In this instance, a plurality of still images may be sequentially displayed in the portable terminal 10 at predetermined time intervals (or periodically) according to the order of the exercise motion.

As illustrated in FIG. 5H, when the exercise motion (for example, the exercise motion 320a) is terminated, the control module 100 may execute a control to display a screen 322 for receiving the feedback with respect to the executed exercise motion 320a. The control module 100 may provide the user 20 with a video of which type of subsequent exercise motion is changed; for example, at least one of the level of difficulty of the exercise motion, the repeat count of the exercise motion, and a performance time. The control module 100 may determine the subsequent exercise type based on a mapping table, such as Table 1 and Table 2. Through the above process, at least one session and/or at least one exercise motion provided to the user 20 in the second process is determined based on the physical state of each body part of the user 20, which is determined through the first process, and an image that is adjusted to be appropriate for the current physical state of the user 20 based on the feedback of the user 20 in the second process may be provided to the user 20. That is, the feedback from the user 20 in the second process may include a function or an operation of re-determining the physical state of the user 20.

An image of which at least one of the level of difficulty, a repeat count, and a performance time is changed, for example, may be stored in the storage module 170, or may be provided from another external electronic device (for example, the telecommunication firm server) through the communication module 110.

FIG. 5I illustrates a screen 323 displayed in the portable terminal 10 when a single session is terminated. The screen 323 may include summary information associated with the executed session. When a session progress icon 323a is selected by the user 20, the control module 100 may execute a control to display a screen 324 for starting a subsequent session in the portable terminal 10, as illustrated in FIG. 5J.

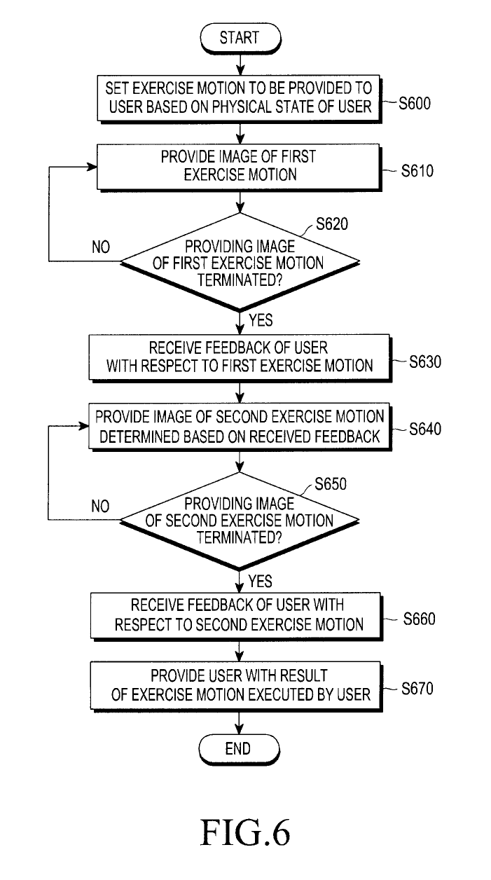

FIG. 6 is a flowchart illustrating operations through which a second process is executed in the portable terminal according to various embodiments of the present disclosure.

Referring to FIG. 6, a controlling method of the portable terminal 10 according to various embodiments of the present disclosure may include operation S600 of setting an exercise motion to be provided to the user 20 based on the physical state of the user 20. As the exercise motion that is set in operation S600, the types of exercise motions may be set to be different for each body part of the user 20 based on the physical state of the user 20, which is determined based on a first process. The type of the exercise motion may include, for example, at least one of the level of difficulty of the exercise motion, the repeat count of the exercise motion, and the performance time. After operation S600, in response to the request of the user 20, an image associated with a first exercise motion from among the various set exercise motions may be provided to the user 20 in operation S610. Although the image may include a video, the image may include at least one still image according to various embodiments of the present disclosure. After operation S610, the portable terminal 10 determines whether providing the image of the first exercise motion is terminated in operation S620, and when providing the image associated with the first exercise motion is terminated, the feedback with respect to the executed first exercise motion is received from the user 20 in operation S630. The feedback may be received from the user 20 in various methods in the same manner as the first process. The portable terminal 10 provides the user 20 with an image of a second exercise motion based on the physical state of the user 20, which is determined (that is, re-determined) based on a result of the input feedback, in operation S640. Although, as described above, the physical state of the user 20 is set to be three levels, which are high, medium, and low, the physical state of the user 20 may be subdivided (for example, level 1 to level 9), according to various embodiments of the present disclosure. Also, the level of difficult of the exercise motion provided to the user 20 and the like may be subdivided to correspond to the subdivided physical state, and may be provided to the user 20. The portable terminal 10 determines whether providing the image of the second exercise motion is terminated in operation S650, and when providing the second exercise motion is terminated, the portable terminal 10 receives the feedback with respect to the second exercise motion from the user 20 in operation S660. After operation S660, the portable terminal 10 determines a result of the executed exercise motion based on the feedback of the user 20, which is received in operations S630 and S660, and provides the same to the user 20, in operation S670. It is understood that the number of exercise motions described in FIG. 6 is provided for illustrative purposes, and the number of exercise motions provided to the user 20 may be changed. In addition, in association with the description associated with FIG. 6, the descriptions associated with the portable terminal 10 according to various embodiments of the present disclosure may be equally applied.

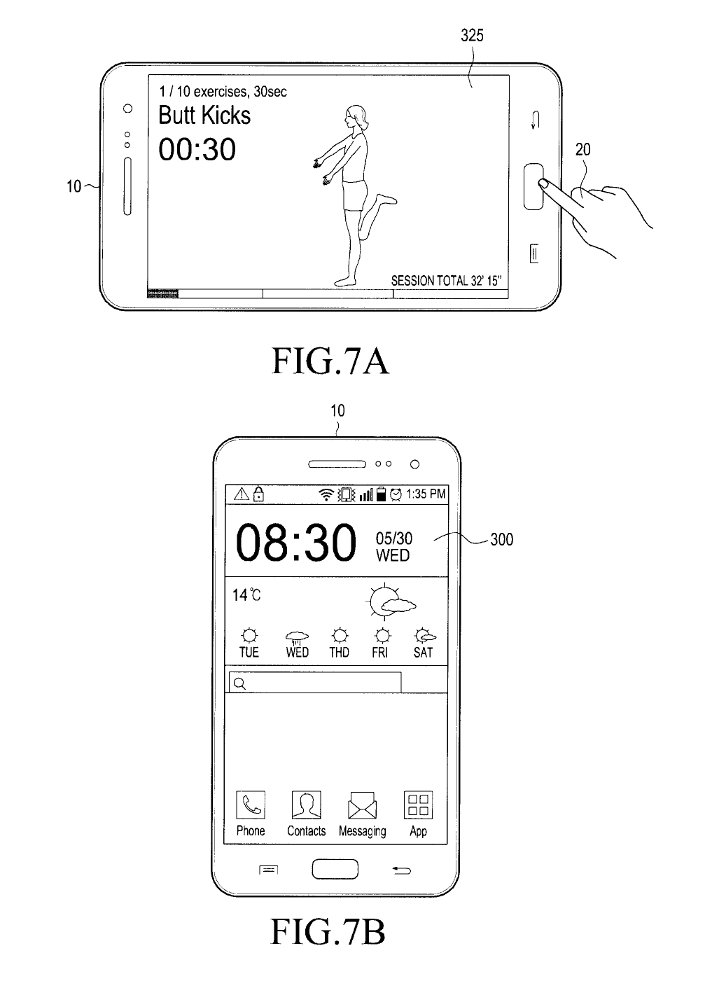

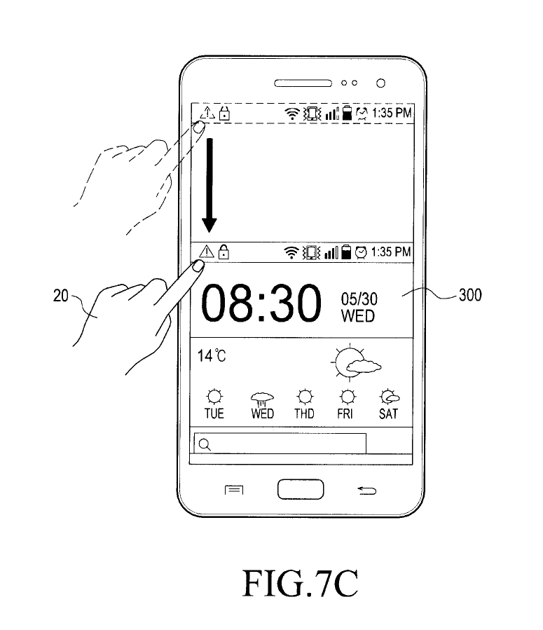

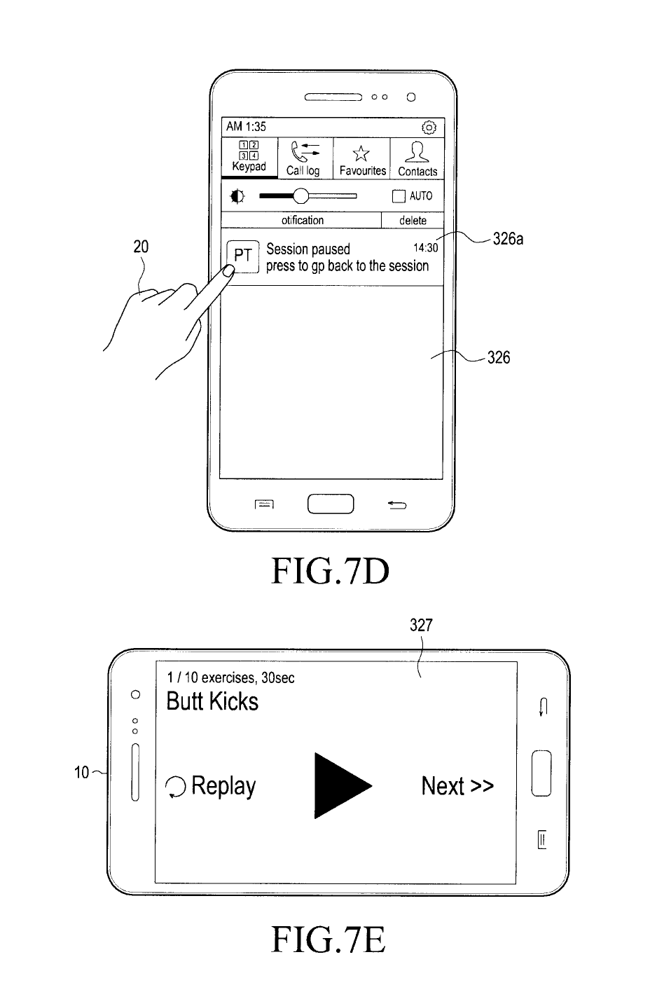

FIGS. 7A to 7E are diagrams illustrating a function or an operation that suspends an image provided to the user 20 in response to an input from the user 20 while a second process is executed according to various embodiments of the present disclosure.

Referring to FIG. 7A, a video 325 corresponding to the exercise motion (for example, the exercise motion 320a) may be reproduced or otherwise displayed in the portable terminal 10. While the video 325 is reproduced, when a home button, for example, is pressed, the control module 100 may execute a control to display the home screen 300 in the portable terminal 10 as illustrated in FIG. 7B. Referring to FIGS. 7C and 7D, the portable terminal 10 may receive a gesture for checking a notification window 326 from the user 20. When a request for executing the health care program (a touch of the user 20 on an item 326a) is received from the user 20 as illustrated in FIG. 7D, the control module 100 may execute a control to display a screen 327 for reproducing the video 325 from the point when the video 325 is suspended as the home button is pressed, as shown in FIG. 7E. Although FIG. 7B illustrates that pressing a home button as an example of suspending the video, this is merely described for the illustrative purpose.

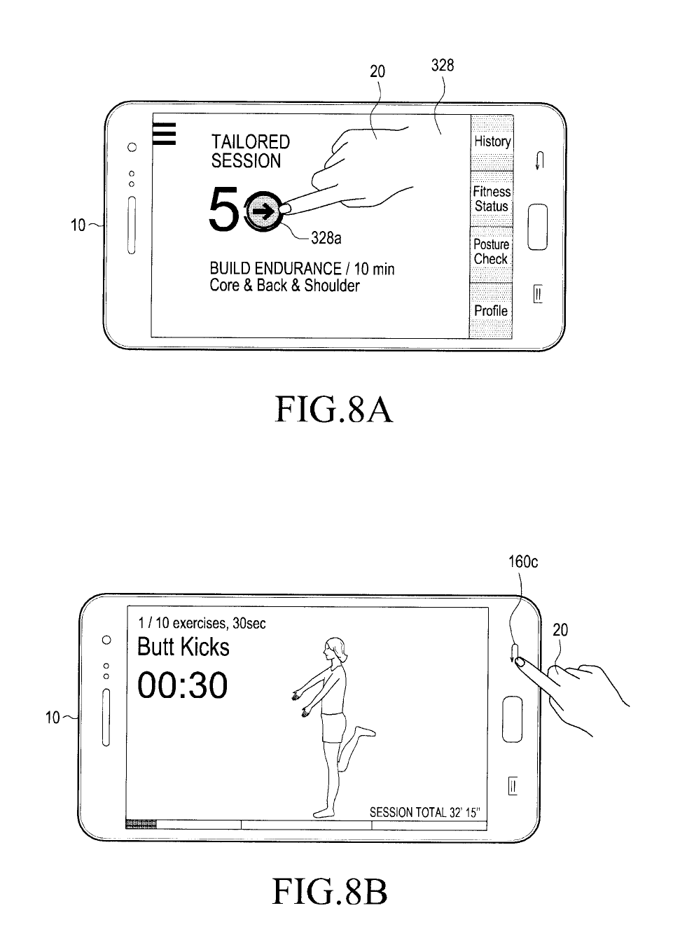

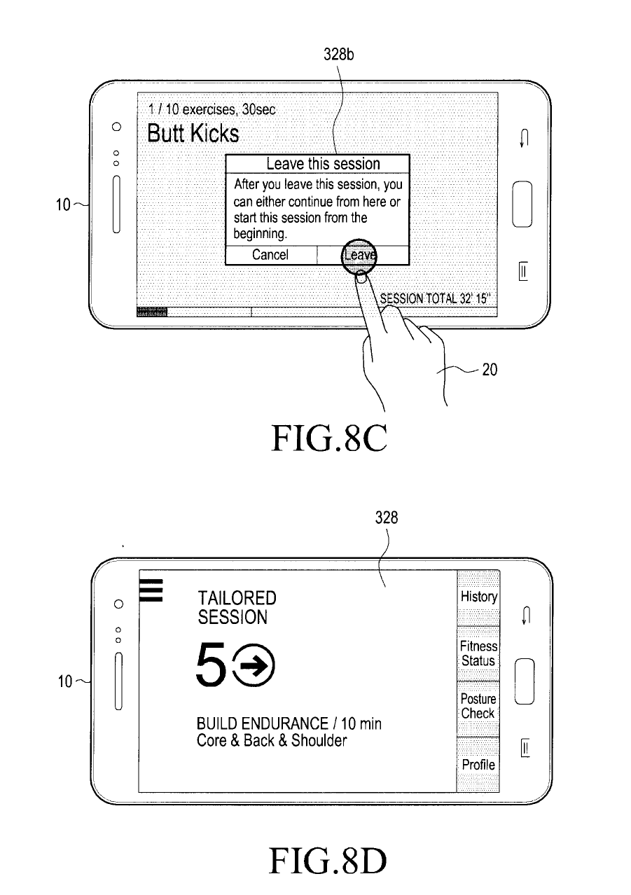

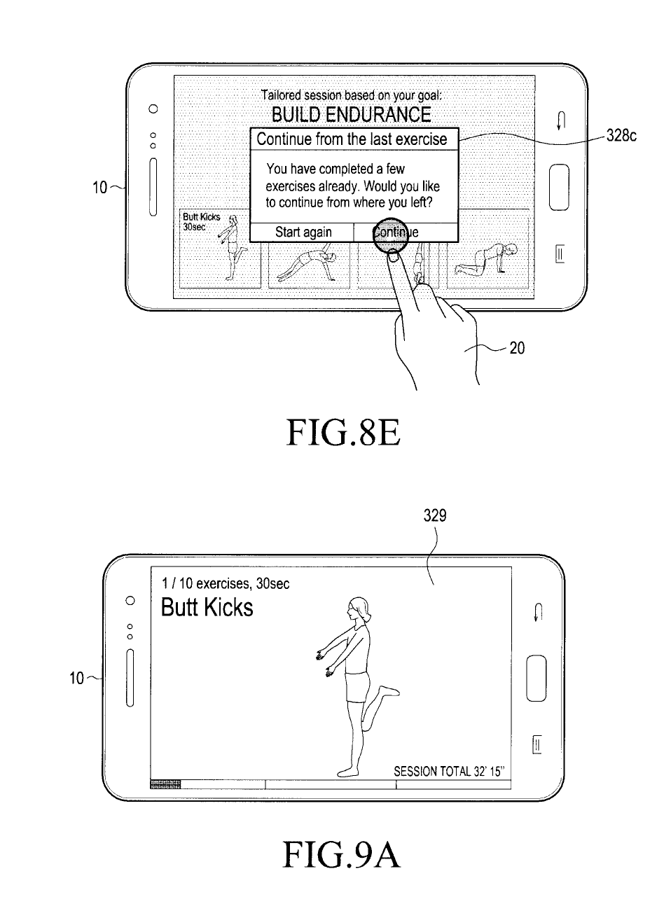

FIGS. 8A to 8E are diagrams illustrating a function or an operation that terminates an image provided to the user 20 in response to an input from the user 20 while a second process is executed according to various embodiments of the present disclosure.

As illustrated in FIG. 8A, the portable terminal 10 may receive a request for executing a session (a touch on a progress icon 328a) from the user 20. In response to the request, the control module 100 may reproduce a video corresponding to an exercise motion included in the session. As illustrated in FIG. 8B, when a request for terminating the session (for example, inputting a back button 160c) is received from the user, the control module 100 may display a termination confirm message 328b. When a request for confirming the termination is received from the user 200, as seen in FIG. 8C, the control module 100 may execute a control to display an initial screen 328 of the session as in FIG. 8D. Also, when a request for restarting the session (for example, a touch on the progress icon 328a) is received from the user 20 after the termination of the session as seen in FIG. 8E, the control module 100 may execute a control to display a guidance message 328c in association with whether to continuously reproduce from the point where the reproduction was ended.

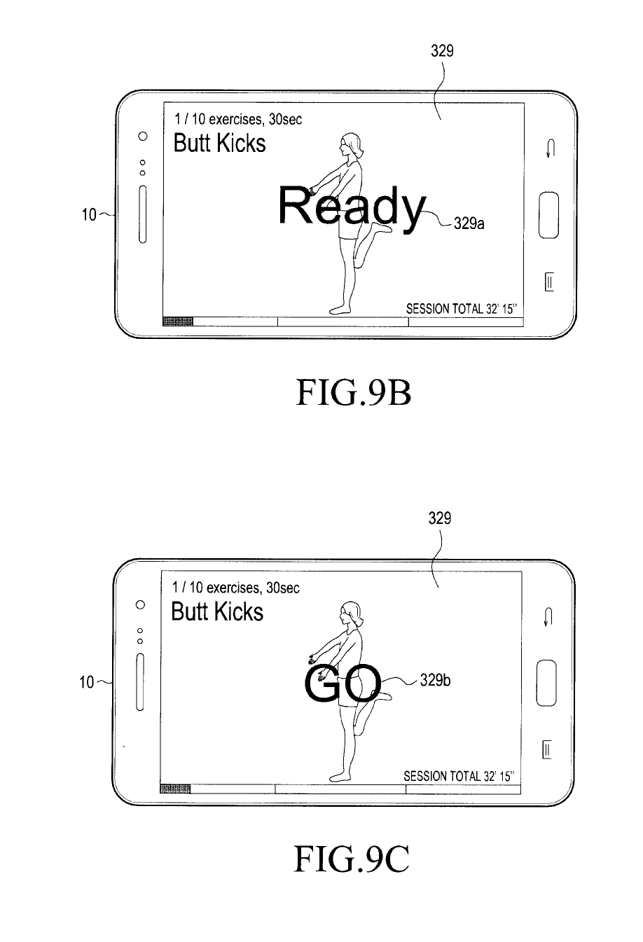

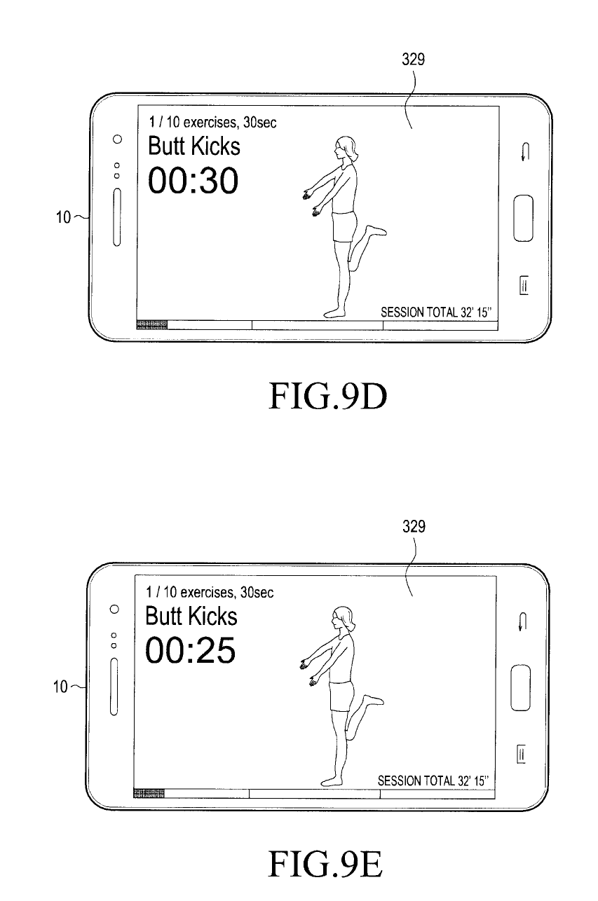

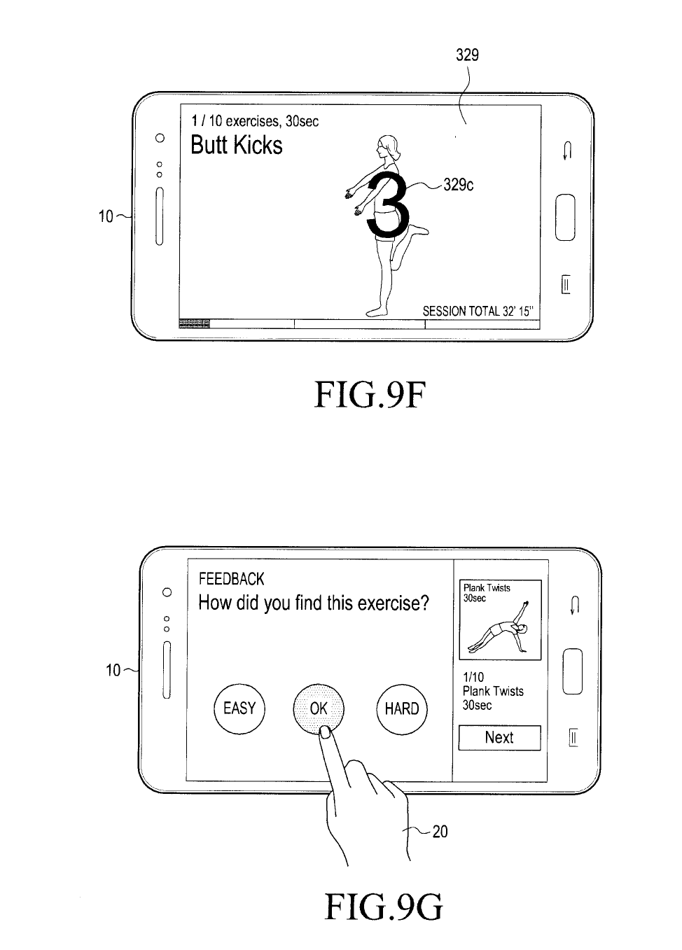

FIGS. 9A to 9G are diagrams illustrating a function or an operation that displays a guidance message indicating the starting and ending of a video provided to the user 20, while a second process is executed according to various embodiments of the present disclosure.

Referring to FIGS. 9A to 9G, a user may be informed of a beginning and end of a video 329 for a particular exercise motion, including a guidance message 329a or 329b indicating a start of the video 329, which may be displayed together with the video 329, as illustrated in FIGS. 9B and 9C. Also, after the video is reproduced as illustrated in FIGS. 9D and 9E, a guidance message 329c reporting, to the user 20, the point where the video 329 is to be ended may be displayed together with the video 329 as shown in FIG. 9F. As described above, after the termination of the video 329, the control module 100 may execute a control to display a screen for receiving, from the user 20, the feedback of the user 20 with respect to the executed exercise motion as illustrated in FIG. 9G, and the portable terminal 10 may receive feedback from the user 20.

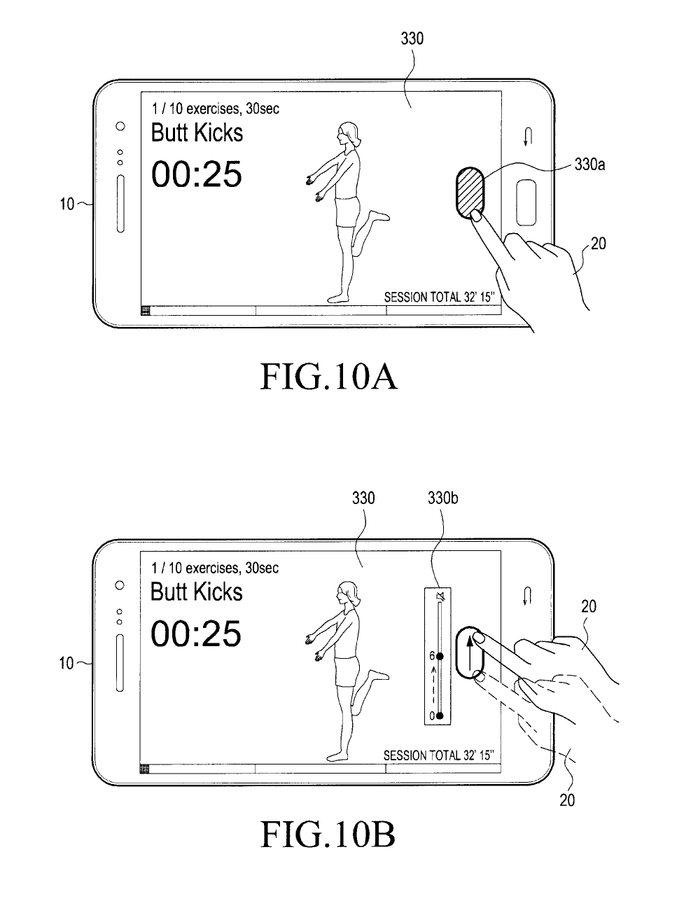

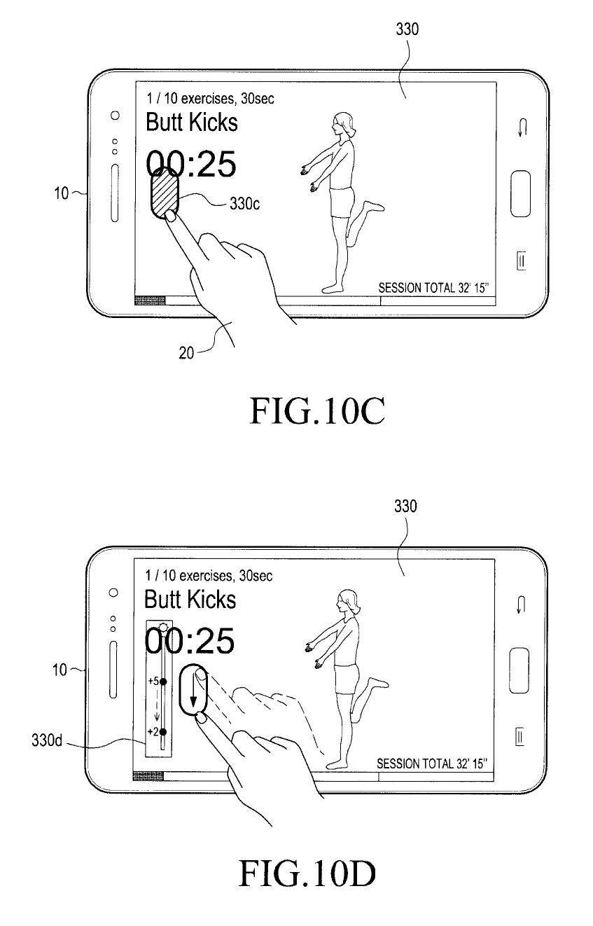

FIGS. 10A to 10D are diagrams illustrating a function or an operation that controls the output settings of a video provided to the user 20 while a second process is executed according to various embodiments of the present disclosure.

Referring to FIGS. 10A to 10D, while a video 330 corresponding to an exercise motion is reproduced, when an input (for example, a panning gesture 330a or 330c) is received from the user 20, the control module 100 may execute a control to display UIs 330b (FIG. 10B) and 330d (FIG. 10D) for controlling the volume or the brightness of the reproduced video, the gesture illustrated in FIGS. 10A and 10B. When an input for controlling the volume or the brightness is received from the user 20, the portable terminal 10 may control the volume or the brightness of the video 3 as illustrated in FIGS. 10B and 10D.

FIG. 11 is a block diagram of a wearable device according to various embodiments of the present disclosure.

Referring to FIG. 11, the wearable device 40, according to various embodiments of the present disclosure, may include a micro controller unit (MCU) 400, a communication module 410, a sensor module 420, an input module 430, a display module 440, a storage module 450, a power management module 460, and a battery 461.

The MCU 400 may execute calculations or data processing associated with the control and/or communication of at least one other element of the wearable device 40.

The communication module 410 may execute transmission and reception of data between the wearable device 40 and another external electronic device (for example, the portable terminal 10) that is connected with the wearable device 40 through the wired/wireless communication. According to various embodiments of the present disclosure, the communication module 410 may include a USB module 411, a WiFi module 412, a BT module 413, an NFC module 414, and a GPS module 415. According to various embodiments of the present disclosure, at least three of the USB module 411, the WiFi module 412, the BT module 413, the NFC module 414, and the GPS module 415 may be included in a single integrated chip (IC) or IC package.

The sensor module 420 may measure a physical quantity or detect an operation state of the wearable device 40, and may convert the measured or detected information to an electrical signal. The sensor module 420, according to various embodiments of the present disclosure, may include, for example, at least one of an acceleration sensor 421, a gyro sensor 422, a geomagnetic sensor 423, a magnetic sensor 424, a proximity sensor 425, a gesture sensor 426, and a biometric sensor 427. Additionally or alternatively, the sensor module 420 may include a biometric sensor, for example, an E-nose sensor, an electromyography (EMG) sensor, an electroencephalogram (EEG) sensor, an electrocardiogram (ECG) sensor, an iris sensor, a finger print sensor or the like, and may recognize the biometric information of the user using the biometric sensor. The sensor module 420 may further include a control circuit for controlling one or more sensors included therein.

The input module 430 may include a touch pad 431 and/or a button 432. The touch pad 431 may recognize a touch input in at least one type among, for example, a capacitive type, a resistive type, an infrared type, and an ultrasonic type. Also, the touch pad 431 may further include a control circuit. In the case of the capacitive type touch panel, recognition of a physical contact or proximity may be possible. The touch panel 431 may further include a tactile layer. In this case, the touch panel 431 may provide a tactile reaction to the user. The button 432 may include, for example, a physical button, an optical key, or a keypad.

The display module 440 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display module 440 may display various types of contents (for example, text, images, videos, icons, or symbols). The display 440 may include a touch screen, and may receive, for example, a touch, gesture, proximity, or hovering input using an electronic pen or a user's body part.

The storage module 450 may include a volatile memory and/or a non-volatile memory. The storage module 450 may store, for example, instructions or data related to at least one other element of the wearable device 40. According to various embodiments of the present disclosure, the storage module 450 may store software and/or various programs.

The power management module 460 may manage the power of the wearable device 40. Although not illustrated, the power managing module 460 may include, for example, a Power Management Integrated Circuit (PMIC), a charger Integrated Circuit (IC), or a battery fuel gauge. The PMIC may be mounted on, for example, an integrated circuit or an SoC semiconductor. Charging methods may be classified into a wired charging method and a wireless charging method. The charger IC may charge a battery and may prevent an overvoltage or excess current from being induced or flowing from a charger. According to an embodiment of the present disclosure, the charger IC may include a charger IC for at least one of the wired charging method and the wireless charging method. A magnetic resonance scheme, a magnetic induction scheme, or an electromagnetic scheme may be exemplified as the wireless charging method, and an additional circuit for wireless charging, such as a coil loop circuit, a resonance circuit, a rectifier circuit, and the like may be added. The battery gauge may measure, for example, a residual quantity of the battery 461, and a voltage, a current, or a temperature during the charging. The battery 461 may store electricity and supply power. The battery 461 may include, for example, a rechargeable battery or a solar battery.

FIGS. 12A to 14C illustrate a “smart watch” as an example of the wearable device 40, and it is merely described for the illustrative purpose and for ease of description. The wearable device 40, according to various embodiments of the present disclosure, may include various devices, for example, a head-mounted-device (HMD) such as electronic glasses, electronic clothes, an electronic bracelet, an electronic necklace, an electronic appcessory, or electronic documents, or the like.

FIGS. 12A to 13D are diagrams illustrating a function or an operation that determines the movement of a user based on movements of the portable terminal and the wearable device obtained through a gyro sensor according to various embodiments of the present disclosure. Hereinafter, embodiments will be described in which the portable terminal 10 and the wearable device 40, according to various embodiments of the present disclosure, which have been described in association with FIG. 11 are connected through wired or wireless communication and the health care program is executed. In association with the contents in addition to the descriptions provided with reference to FIGS. 12A to 16B, the descriptions associated with the first process that have been described with reference to FIGS. 2A to 2P and the second process that have been described with reference to FIGS. 5A to 5J may be equally applied unless the descriptions conflict with the descriptions associated with the FIG. 12A to FIG. 16B.

FIGS. 12A to 12C illustrate the principal in which the movement of the wearable device 40 is detected by the gyro sensor 422 included in the wearable device 40.

FIG. 12A illustrates the case in which the movement of the wearable device occurs based on the Z axis. FIG. 12B illustrates the case in which the movement of the wearable device 40 occurs based on the X axis. FIG. 12C illustrates the case in which the movement of the wearable device 40 occurs based on the Y axis.

In each case of FIGS. 12A to 12C, the MCU 400 may determine the movement of the wearable device 40 based on a factor (for example, alpha (α), beta (β), gamma (γ)) that varies according to the movement of the wearable device 40. Also, various methods according to the conventional art may be applied to the operation of determining the movement of the user 20 using a gyro sensor contained in an electronic device, such as the wearable device 40. Also, according to various embodiments of the present disclosure, when the movement of the user 20 is detected through the movement of the wearable device 40, the acceleration sensor 421 may be used together with the gyro sensor 422.

FIGS. 13A to 13D illustrate an example of actually detecting the movement of the user 20 through the wearable device 40. FIGS. 13A to 13D illustrate the case in which the user 20 executes a push-up motion as an example of an exercise movement of the user 20.

Referring to FIG. 13A, the values of α, β, and γ may be 120, 10˜20, and 40˜50, respectively, while the user gets into the ready position of the push-up motion.

Referring to FIGS. 13B to 13D, while the user 20 executes the push-up motion, the movement of the wrist of the user 20 which wears the wearable device 40 may occur (for example, the wrist is rotate or twisted), and thus, the values of α, β, and γ may vary. For example, in the case of the movement of the user 20 in FIG. 13B and FIG. 13D, the values of α, β, and γ may be 122, 20˜25, and 50˜60, respectively.

Referring to FIG. 13C, the movement that is in a different direction and has a different angle from the movement of the wrist illustrated in the FIGS. 13A, 13B, and 13D may be detected by the gyro sensor from the motion illustrated in FIG. 13C. For example, in the case of the motion illustrated in FIG. 13C, the values of α, β, and γ may be 122, 25˜30, and 60˜70, respectively. As described above, when the wearable device is worn on a body part of the user 20 and a movement, such as the push-up motion occurs, a change in the movement of the user 20 may be detected through the wearable device 40. Also, the MCU 400 may execute a control to transmit the obtained information associated with the values of α, β, and γ, to the portable terminal 10 through the communication module 410.

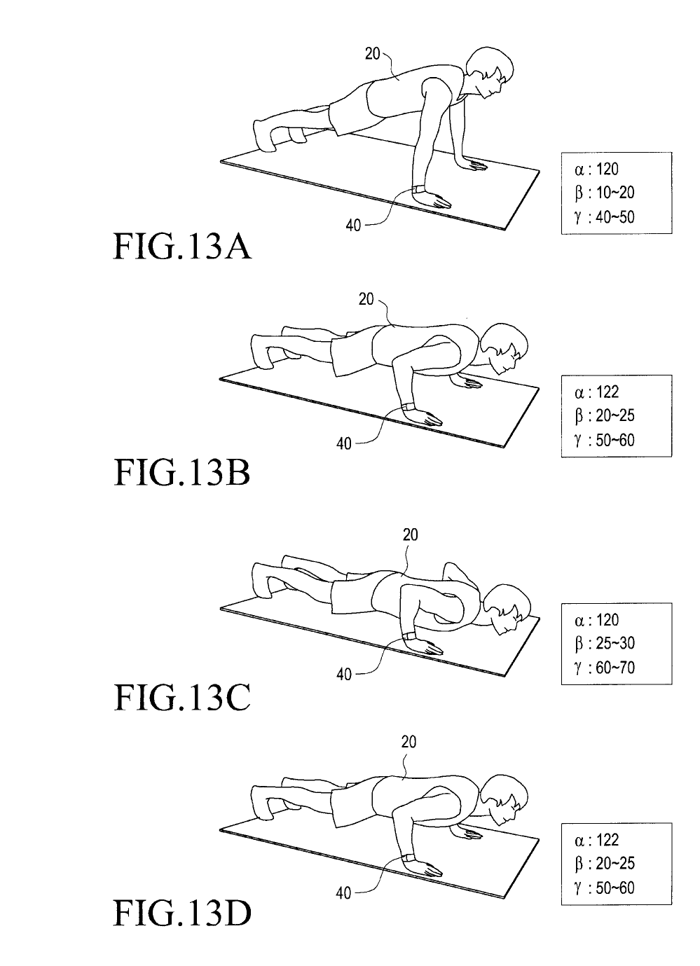

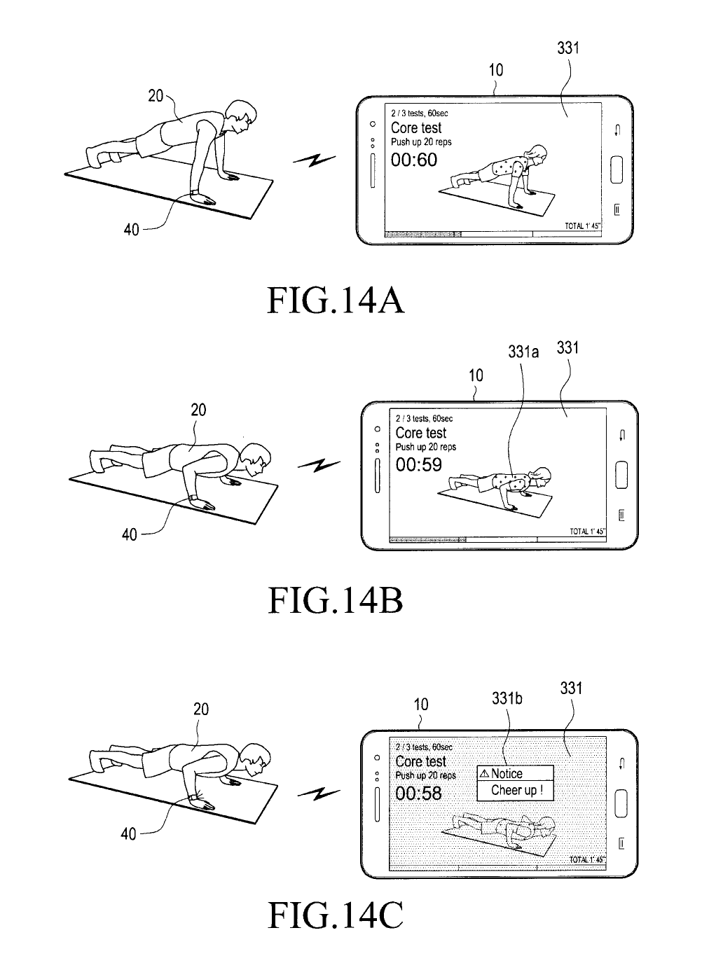

FIGS. 14A to 14C are diagrams illustrating a function or an operation of comparing an exercise posture of the user 20 and an exercise posture in an image provide to the user 20, through a wearable device according to various embodiments of the present disclosure.

Referring to FIG. 14A, the control module 100 may execute a control to enable the wearable device 40 that is worn on a body part of the user 20 (for example, the wrist of the user 20) and the portable terminal 10 to be connected or otherwise communicatively coupled through wireless communication. In the state in which the wearable device 40 and the portable terminal 10 are connected through the wireless communication, the control module 100 may display a video 331 corresponding to an exercise motion (for example, a push-up) in the portable terminal 10, in response to a request from the user 20.

Referring to FIG. 14B, while the push-up motion is executed, when the movement of the wrist of the user occurs, the values of factors (for example, the values of α, β, and γ), which are determined (or vary) based on the movement of the user 20, may be received from the wearable device 40. Also, the control module 100 may receive, from the wearable device 40, time information in association with the time elapsed from a point when a video 331 begins in the portable terminal 10. To this end, when the reproduction of the video 331 begins in the portable terminal 10, the control module 100 may execute a control to notify the wearable device 40 that the reproduction begins. Also, to determine whether the movement of the user 20 is identical to the movement of an object 331a (for example, a trainer) in the reproduced video 331, the values of α, β, and γ associated with the movement of the object 331a for each of the frames forming the video 331 may be stored in the storage module 170, separately from the video 331. Also, the values of α, β, and γ may be stored in a field (for example, a header field) that forms the video 331. The control module 100 may execute a control to receive the values of α, β, and γ and time information from the wearable device 40, for each reproduction time (for example, for each 0.05 seconds) of each frame. The control module 100 may compare the movement of the user 20 and the movement of the object 331a based on the values of α, β, and γ and the time information that are received from the wearable device 40, and may determine whether the user exercises in the right posture. When it is determined that the values of α, β, and γ are included in a predetermined error range based on the values of α, β, and γ, and the time information, the control module 100 may determine that the user 20 exercises in the right posture. According to various embodiments of the present disclosure, the control module 100 may execute a control to receive the values of α, β, and γ from the wearable device 40, without receiving the time information. FIG. 14A and FIG. 14B illustrate the case in which the user 20 exercises in the right posture.

However, when the values of α, β, and γ exceed the predetermined error range, the control module 100 may determine that the user 20 exercises in an inaccurate posture. In this instance, the control module 100 may execute a control to display a notification message 331b, as illustrated in FIG. 14C. Also, the control module 100 may transmit, to the wearable device 40, a request for outputting a message for informing the user 20 that the user 20 exercises in an inaccurate posture. Accordingly, the MCU 400 may execute a control to output a visual, aural, or tactual notification.

According to the embodiments described with reference to FIGS. 12A to 14C, the control module 100 may determine the feedback of the user 20 such as the valid count of the exercise and/or the valid time, without an input that is manually provided by the user 20. For example, when the valid count within a predetermined time is less than a predetermined count, the control module 100 may automatically (that is, without inputting feedback by the user 20) determine that the exercise motion provided to the user 20 through the portable terminal 10 is difficult for the user 20. Accordingly, the control module 100 may lower the level of the difficulty of the exercise motion when providing a subsequent exercise motion to the user 20 in the second process.

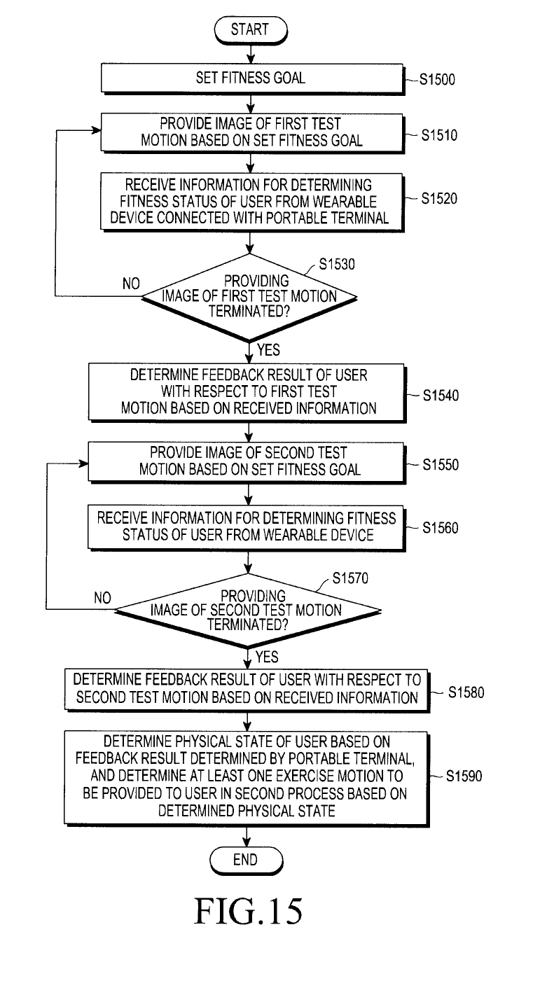

FIG. 15 is a flowchart illustrating operations in which a first process is executed through the wearable device 40 and the portable terminal 10 that is connected with the wearable device 40.

Referring to FIG. 15, a controlling method of the portable terminal 10 according to various embodiments of the present disclosure may include operation S1500 in which the portable terminal 10 sets a fitness goal. Setting the fitness goal may be executed, for example, by receiving selection information associated with the fitness goal from the user 20. Also, after operation S1500, the portable terminal 10 may include operation S1510 in which an image of a first test motion (for example, “superman hold”) in association with the set fitness goal is provided to the user 20. In operation S1520, the portable terminal 10 receives information for determining the fitness status (for example, whether the exercise motion of the user 20 is identical to the exercise motion provided through the portable terminal 10, a valid time and/or a valid count) of the user 20 in association with the first test motion from the wearable device that is connected with the portable terminal 10, while operation 1510 is executed. After operations S1510 and S1520, the portable terminal 10 determines whether providing the image of the first test motion is terminated in operation S1530. When providing the image of the first test motion is terminated, the portable terminal 10 determines a feedback result with respect to the first test motion, based on the information for determining the fitness status of the user 20, which is received from the wearable device 40, in operation S1540. After operation S1540, the portable terminal 10 provides an image of a second test motion (for example, “push-up”) in response to the request from the user 20, in operation S1550. While operation S1550 is executed, the portable terminal 10 receives information for determining the fitness status of the user in association with the second test motion, from the wearable device 40, in operation S1560. After operations S1550 and S1560, the portable terminal 10 determines whether providing the image of the second test motion is terminated in operation S1570. When providing the image of the second test motion is terminated, the portable terminal 10 determines a feedback result with respect to the second test motion, based on the information for determining the fitness status of the user 20, which is received from the wearable device 40, in operation S1580. After operation S1580, the portable terminal may include operation S1590 that determines the current physical state of the user 20 based on the feedback result of the user 20, which is determined in operations S1540 and S1580, and determines, based on the determined physical state, at least one exercise motion to be provided to the user 20 in the second process. According to various embodiments of the present disclosure in association with FIG. 15, the “first test motion” and the “second test motion” may be executed by being replaced with a “first test item” and a “second test item.” The number of test motions (or test items) described in FIG. 15 is merely described for the illustrative purpose, and embodiments of the present disclosure may not be limited thereto. In addition, in association with the controlling method of the portable terminal 10, which has been described with reference to FIG. 15, the descriptions with reference to FIG. 12A and FIG. 14C may be equally applied, and the descriptions with reference to FIGS. 2A to 2P may be equally applied unless the descriptions conflict with the embodiments described with reference to FIG. 15.

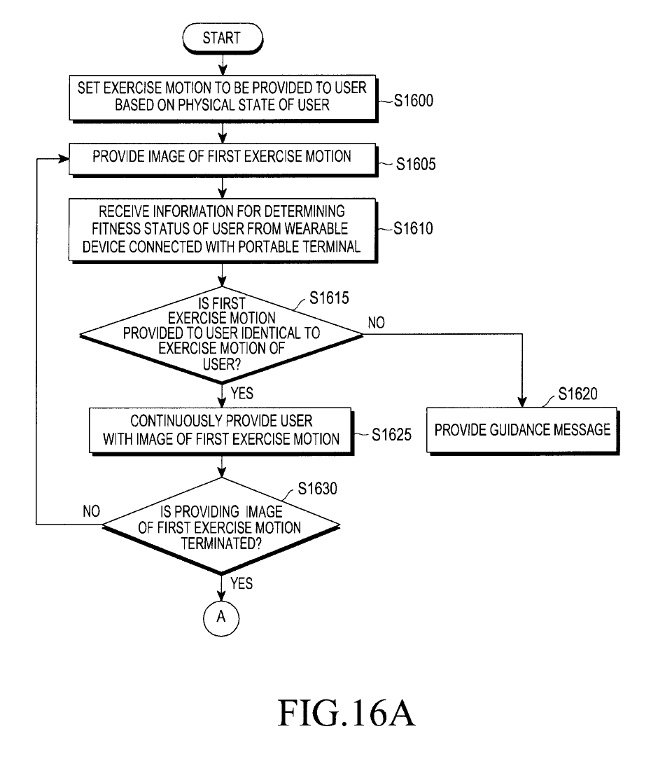

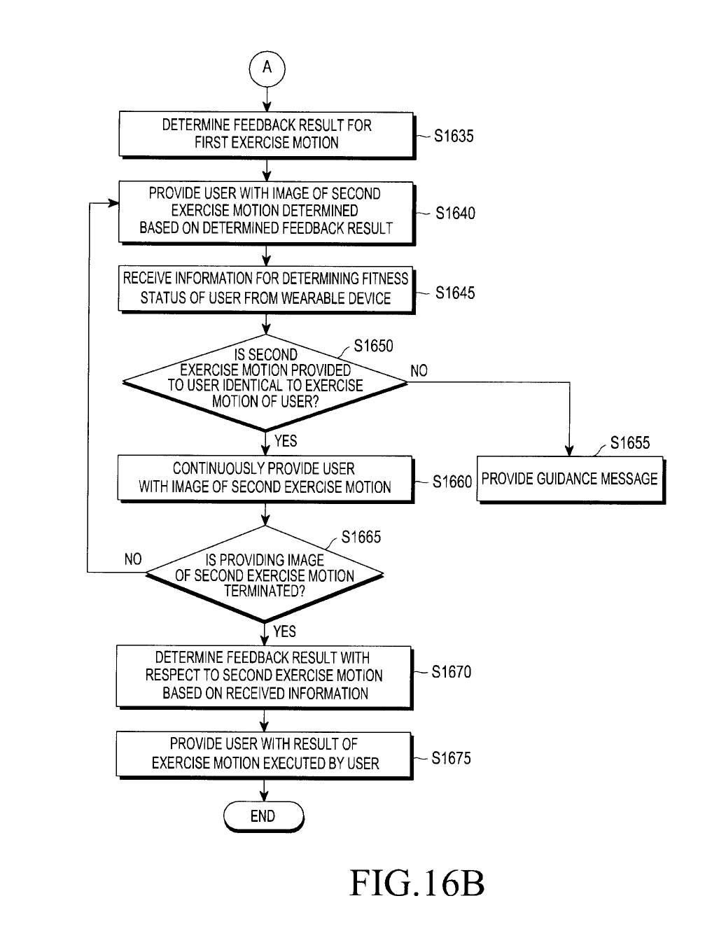

FIG. 16 is a flowchart illustrating operations through which a second process is executed through the wearable device and the portable terminal that is connected with the wearable device.

Referring to FIG. 16A and FIG. 16B, the portable terminal 10 sets an exercise motion provided to the user 20, based on the physical state of the user 20, in operation S1600. As the exercise motion provided to the user 20, different types of exercise motions may be provided for different body parts of the user 20. The type of the exercise motion may include, for example, the level of difficulty of the exercise motion, a repeat count in association with the exercise motion, and a performance time. After operation S1600, in response to a request from the user 20, the portable terminal 10 provides the user 20 with an image of a first exercise motion from among the various set exercise motions in operation S1605. While operation S1605 is executed, the portable terminal 10 receives information for determining the fitness status of the user from the wearable device 40, which is connected with the portable terminal 10 through wired or wireless communication, in operation S1610. Although the image includes a video, the image may include at least one still image according to various embodiments of the present disclosure. The portable terminal 10 determines whether the exercise motion of the user 20 is identical to the first exercise motion provided through the portable terminal 10 based on the information for determining the fitness status of the user, which is received from the wearable device 40, in operation S1615.

When the result of the determination in operation S1615 shows that a difference between the exercise motion of the user 20 and the exercise motion provided to the user through the portable terminal 10 exceeds a predetermined error range, the portable terminal 10 provides the user 20 with a predetermined guidance message (for example, the guidance message 331a), in operation S1620. The guidance message may be provided to the user 20 in at least one of a visual scheme, an aural scheme, and a tactual scheme. In operation S1620, the image provided by the portable terminal 10 may be suspended or continuously provided (for example, reproduced), while the guidance message is provided to the user 20. In operation S1620, the portable terminal 10 may execute operation S1610 with the wearable device 40 at predetermined time intervals (or periodically), and when the fitness status of the user 20 is identical to the first exercise motion within the predetermined error range, the portable terminal 10 stops providing the guidance message and provides the image of the first exercise motion again to the user 20.

When the result of the determination in operation S1615 shows that the exercise motion of the user 20 is identical to the exercise motion provided to the user 20 through the portable terminal 10 within the predetermined error range, the portable terminal continuously provides (that is, not providing the user 20 with the guidance message) the user 20 with the image of the first exercise motion in operation S1625. After operations S1605 to 1625, the portable terminal 10 determines whether providing the image of the first exercise motion is terminated in operation S1630, and when the first exercise motion is terminated, the portable terminal 10 determines a feedback result with respect to the first exercise motion based on the information for determining the fitness status of the user 20, which is received from the wearable device 40 in operation S1635. The portable terminal 10 may provide the user 20 with a second exercise motion set (just as in operation S1600), or as depicted in FIG. 16B, the portable terminal 10 may provide the user 20 with an image of which at least one of the level of difficulty of the second exercise motion that is to be executed subsequent to the first exercise motion, a repeat count of the second exercise motion, and a performance time is changed (that is, an image of the second exercise motion determined based on the determined feedback result) in operation S1640. The level of difficulty may be set as, for example, three levels. This is merely provided for the illustrative purpose, and the level of difficulty may be subdivided based on the type and the feature of each exercise motion. While operation S1640 is executed, the portable terminal 10 receives information for determining the fitness status of the user 20 from the wearable device 40 that is connected with the portable terminal 10 through wired or wireless communication, in operation S1645. The portable terminal 10 determines whether the exercise motion of the user 20 is identical to the second exercise motion provided through the portable terminal 10 based on the information for determining the fitness status of the user 20, which is received from the wearable device 40, in operation S1650. When the result of the determination in operation S1650 shows that a difference between the exercise motion of the user 20 and the exercise motion provided to the user 20 through the portable terminal 10 exceeds a predetermined error range, the portable terminal 10 includes operation S1655 that provides the user 20 with a predetermined guidance message (for example, the guidance message 331a). In operation S1655, the image that is reproduced in the portable terminal 10 may be suspended or may be continuously reproduced. The guidance message may be provided to the user 20 in at least one of a visual scheme, an aural scheme, and a tactual scheme. In operation S1655, the portable terminal 10 may execute operation S1645 with the wearable device 40 based on a predetermined time interval, and when the fitness status of the user 20 is identical to the second exercise motion within the predetermined error range, the portable terminal 10 may terminate providing of the guidance message and redisplay or maintain display of the image of the second exercise motion again to the user 20.

When the result of the determination in operation S1650 shows that the exercise motion of the user 20 is identical to the exercise motion provided to the user 20 through the portable terminal 10 within the predetermined error range, the portable terminal 10 continuously provides the user 20 with the image of the second exercise motion that is provided through the portable terminal 10 in operation S1660. After operations S1640 to 1660, the portable terminal 10 determines whether providing the image of the second exercise motion is terminated in operation S1665, and when the second exercise motion is terminated, the portable terminal 10 determines a feedback result with respect to the second exercise motion based on the information for determining the fitness status of the user 20, which is received from the wearable device in operation S1670. The portable terminal 10 determines a result of the exercise motion of the user 20, which is executed in the second process, based on the information transmitted from the wearable device 40 and the feedback result determined based on the information in operation S1670, and provides the determined result to the user 20 in operation S1675. The number of exercise motions described in FIGS. 16A and 16B is merely described for illustrative purposes, and embodiments of the present disclosure may not be limited thereto. In addition, in association with the controlling method of the portable terminal 10, which is described with reference to FIGS. 16A and 16B, the descriptions with reference to FIG. 12A and FIG. 14C may be equally applied, and the descriptions with reference to FIGS. 5A to 5J may be equally applied unless the descriptions conflict with the embodiments described with reference to FIGS. 16A and 16B.

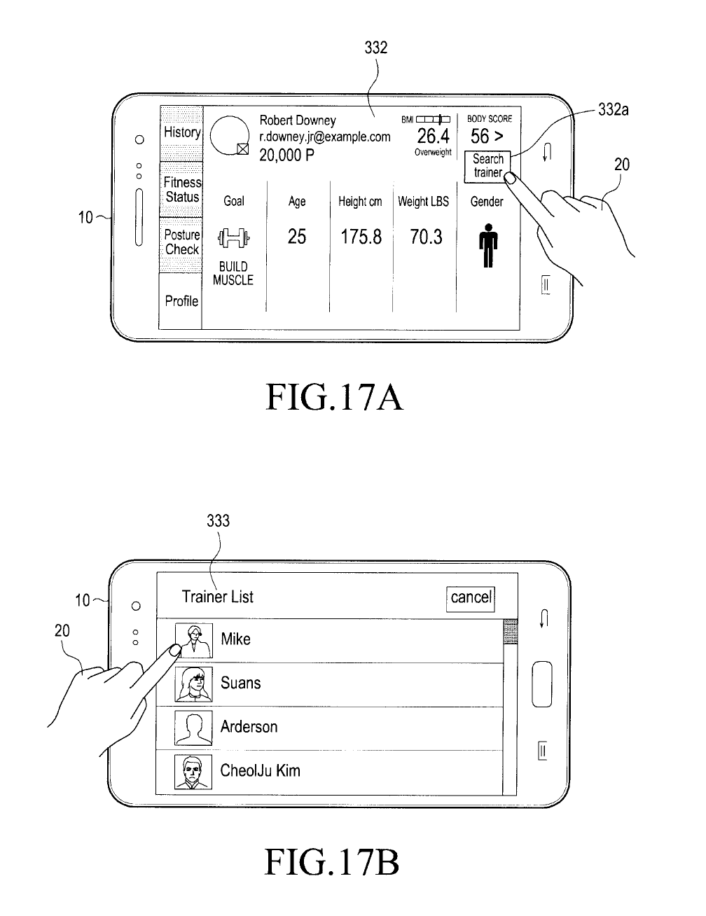

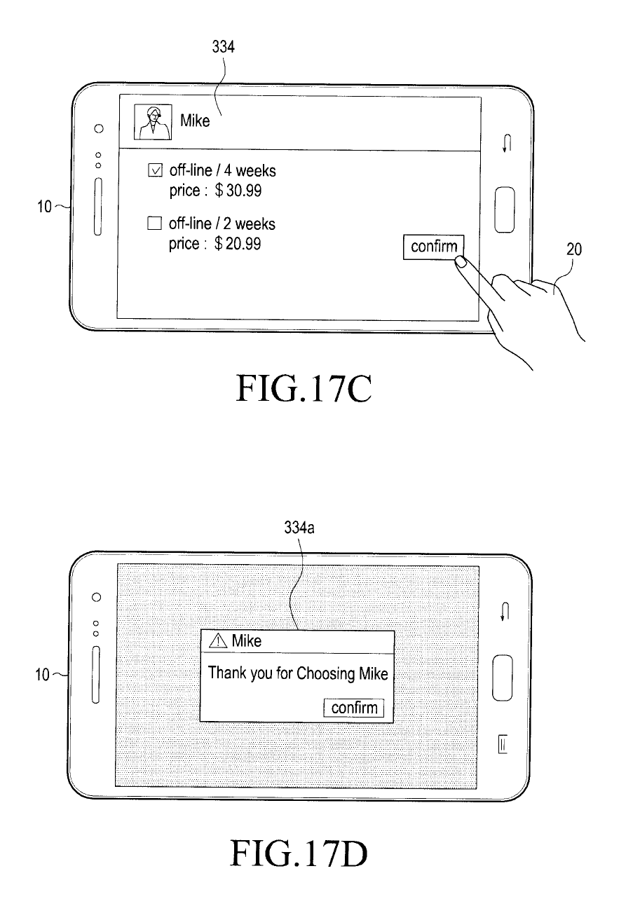

FIGS. 17A to 17D are diagrams illustrating a function or an operation of selecting a personal trainer of the user 20 in the second process according to various embodiments of the present disclosure.

Referring to FIGS. 17A to 17D, the control module 100 may receive an input, from the user 20 in screen 332, for requesting the provision of personal trainer information. The input that requests providing the personal trainer information may be provided by, for example, selecting a trainer search icon 332a. When the request is received, the control module 100 may display a list 333 of various trainers registered in the health care program, as illustrated in FIG. 17B. The portable terminal 10 may receive an input for selecting at least one trainer out of the list of the trainers from the user 20. When the trainer is selected in response to the request from the user 20, the control module 100 may display a screen 334 that provides the user 20 with a guidance in association with the costs for registering with the trainer. The user 20 may determine the information associated with the trainer displayed in the portable terminal 10, and may proceed with registering the class of the trainer, as illustrated in FIGS. 17C and 17D.

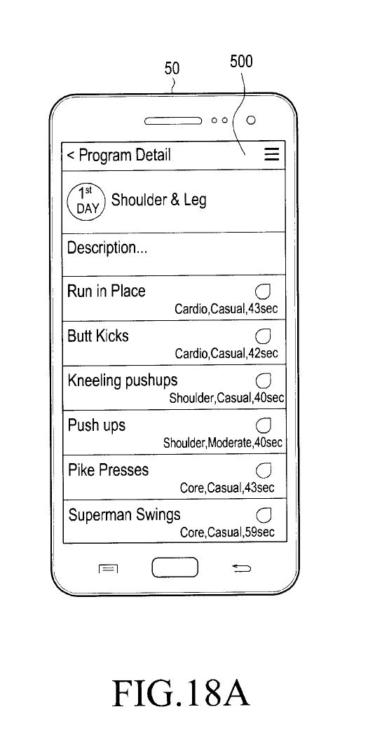

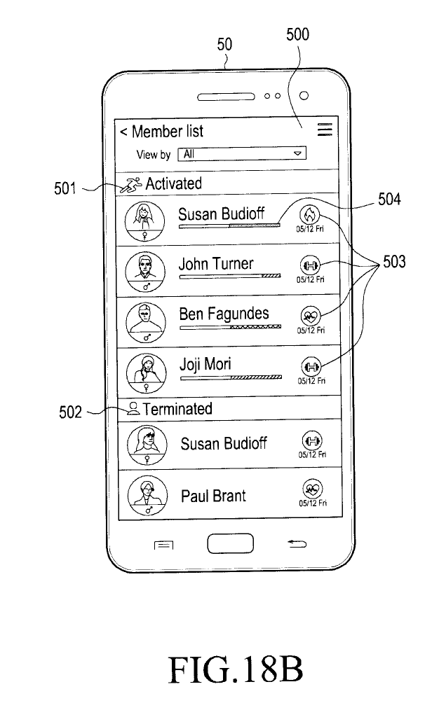

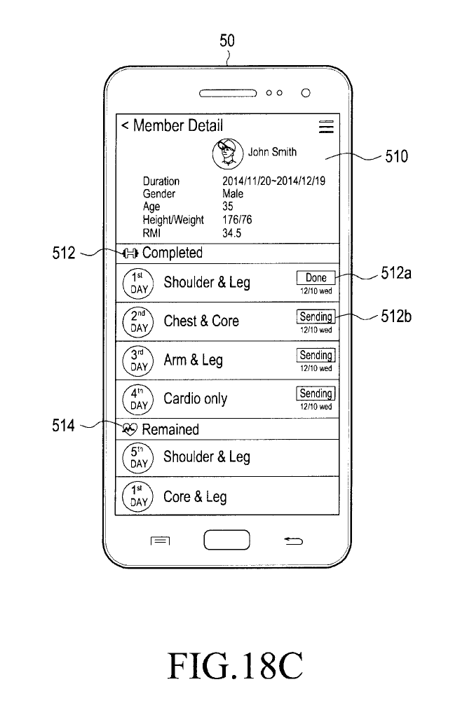

FIGS. 18A to 18C are diagrams illustrating a function or an operation of managing a health care program of the user 20 by a personal trainer selected by the user 20.

Referring to FIG. 18A, exercise motions may be received from the selected trainer, as illustrated in FIG. 18A. An electronic device (e.g., a portable terminal) 50 of the selected trainer may execute a control to display information screen 500 for members who register with the trainer as a personal trainer, as illustrated in FIGS. 18B and 18C. As illustrated in FIG. 18B, in the electronic device 50 of the trainer, exercise achievement 504 and a session 503 provided by the trainer of each user may be displayed. Also, a list 501 of members whose memberships are valid and a list 502 of members whose memberships expire may be displayed. Also, as illustrated in FIG. 18C, the electronic device 50 of the trainer may display a screen 510 for the detailed information of a member. The screen 510 may include information 512 and 514 associated with exercise motions or sessions, which were provided or are to be provided by the trainer. With respect to the exercise motion and session that were provided to the member, an icon 512a or 512b indicating whether the member completes the exercise may be displayed.

The “unit” or “module” used in various embodiments of the present disclosure may refer to, for example, a “unit” including one of hardware, software, and firmware, or a combination of two or more of the hardware, software, and firmware. The “unit” or “module” may be interchangeable with a term, such as a unit, a logic, a logical block, a component, or a circuit. The “unit” or “module” may be mechanically or electronically implemented. For example, the “module” according to various embodiments of the present disclosure may include at least one of an Application-Specific Integrated Circuit (ASIC) chip, a Field-Programmable Gate Arrays (FPGAs), and a programmable-logic device for performing operations which have been known or are to be developed hereafter.

While the embodiment of the present disclosure has been described with reference to the accompanying drawings, it will be understood by those skilled in the art that the present disclosure may be varied and modified without departing from the present disclosure. Accordingly, it should be understood that the embodiments described above are merely examples and the present disclosure is not limited to the specific embodiments described above.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A portable terminal, comprising:
a display module; and
at least one processor operatively coupled to memory, configured to:
control the display module to display a first image operable to indicate a state of a user, and
in response to receiving response information while the first image is displayed, determine a state of the user according to the received response information.

2. The portable terminal of claim 1, wherein the at least one processor is further configured to:
detect an exercise movement to be displayed to the user based on the determined state of the user, and
control the display module to display a visual guide for performing the detected exercise movement.

3. The portable terminal of claim 2, further comprising: a communication module, wherein the at least one processor is further configured to:
receive, via the communication module, transmission of the response information from a wearable device worn by the user.

4. The portable terminal of claim 3, wherein the response information comprises movement information generated by movement of the user as measured by the wearable device and transmitted to the portable terminal.

5. The portable terminal of claim 4, wherein the at least one processor is further configured to:
detect the movement of the user via at least the response information; and
determine a fitness status of the user by comparing the movement of the user to the exercise movement displayed in the visual guide.

6. The portable terminal of claim 5, wherein
comparing the movement of the user and the exercise movement displayed in the visual guide at predetermined time intervals, and
determining the fitness status of the user is based on a determination of whether the movement of the user is within a predetermined error range of the exercise movement displayed in the visual guide.

7. The portable terminal of claim 6, wherein, when a difference between the movement of the user and the exercise movement displayed in the visual guide exceeds the predetermined error range, the at least one processor is further configured to control the display module to display a predetermined guidance message.

8. The portable terminal of claim 5, wherein the at least one processor is further configured to determine the fitness status of the user by comparing the exercise movement displayed in the visual guide and the movement of the user, based on the movement information generated by movement of the user as measured by the wearable device and received via the communication module.

9. The portable terminal of claim 8, wherein the state of the user includes a physical state of the user, and the at least one processor is further configured to determine the physical state of the user based at least on the determined fitness status of the user.

10. The portable terminal of claim 3, wherein the visual guide for performing the detected exercise movement is received via the communication module from a pre-designed external electronic device and based on the determined state of the user.

11. A method in a portable terminal, comprising:
displaying a first image operable to indicate a state of a user of the portable terminal; and
in response to receive response information while the first image is displayed, determining a state of the user according to the received response information.

12. The method of claim 11, further comprising:
detecting an exercise movement to be displayed to the user based on the determined state of the user; and
displaying a visual guide for performing the detected exercise movement.

13. The method of claim 12, further comprising:
receiving, via a communication module, transmission of the response information from a wearable device worn by the user.

14. The method of claim 13, wherein the response information comprises movement information generated by movement of the user as measured by the wearable device and transmitted to the portable terminal.

15. The method of claim 14, further comprising:
determining a fitness status of the user by comparing the movement of the user and the exercise movement displayed in the visual guide, based on the movement information generated by movement of the user as measured by the wearable device and transmitted to the portable terminal.

16. The method of claim 15, wherein the determining the fitness status of the user comprises:
comparing the movement of the user and the exercise movement displayed in the visual guide at predetermined time intervals; and
determining the fitness status of the user based on a determination of whether the movement of the user is within a predetermined error range of the exercise movement displayed in the visual guide.

17. The method of claim 16, wherein, when a difference between the movement of the user and the exercise movement displayed in the visual guide exceeds the predetermined error range, displaying a predetermined guidance message.

18. The method of claim 15, further comprising:
comparing the exercise movement displayed in the visual guide and the movement of the user, based on the movement information generated by movement of the user as measured by the wearable device and received via the communication module.

19. The method of claim 18, wherein the state of the user includes a physical state of the user, the method further comprising determining the physical state of the user based at least on the determined fitness status of the user.

20. The method of claim 12, wherein the visual guide for performing the detected exercise movement is received via a communication module from a pre-designed external electronic device and based on the determined state of the user.
